(19) United States
(12) Patent Application Publication
(10) Pub. No.: US 2026/0340555 A1
(43) Pub. Date: Oct. 29, 2026

(54) SOFTWARE AND METHODS FOR GUIDING INDUSTRY TRANSITION TO NET-ZERO EMISSIONS

(71) Applicants: Arizona Board of Regents on Behalf of Arizona State University, Scottsdale, AZ (US); Ohio State Innovation Foundation, Columbus, OH (US)

(72) Inventors: Amrita Sen, Midland, MI (US); Vyom Thakker, Hillsboro, OR (US); Aniket Mali, Tempe, AZ (US); Jaafar Ballout, Tempe, AZ (US); Nandita Saraf, Bhilai (IN); Reena Sharma, Tempe, AZ (US); Farshid Nazemi, Tempe, AZ (US); George Stephanopoulos, Winchester, MA (US); Bhavik Bakshi, Scottsdale, AZ (US)

(21) Appl. No.: 19/655,322

(22) Filed: Apr. 22, 2026

Related U.S. Application Data
(60) Provisional application No. 63/794,704, filed on Apr. 25, 2025.

(51) Int. Cl. G06Q 10/0637; G06N 3/086; G06Q 10/30

(52) U.S. Cl. CPC G06Q 10/0637; G06N 3/086; G06Q 10/30

(57) ABSTRACT

A method for leveraging artificial neural networks (ANNs) to develop a transition roadmap toward net-zero emissions and circularity. The method involves obtaining datasets that quantify circularity and life-cycle environmental impact thresholds over a configurable time horizon, along with quantified technology readiness levels (TRLs) for multiple transition technologies. An ANN is trained using these datasets and a training algorithm, which incorporates an evolution function to model technology progressions and a trade-off function to evaluate threshold satisfaction at various stages. The trained ANN identifies a subset of technologies that meet the circularity and environmental impact thresholds across the entire timeline. The resulting roadmap outlines these technologies relative to the time horizon, providing a data-driven guide for achieving sustainability goals while balancing technological advancements and environmental considerations.

### CLAIM OF PRIORITY

This application claims the benefit of U.S. Patent Application No. 63/794,704, filed 25 Apr. 2025, the entire contents of which is incorporated herein by reference.

### GOVERNMENT INTEREST

This invention was made with government support under 2433265 awarded by the National Science Foundation. The government has certain rights in the invention.

### TECHNICAL FIELD

Aspects of the disclosure relate generally to computing systems, and more particularly to systems, methods, and apparatuses for implementing a net-zero emission and resource efficient roadmap development tool.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to examples of the claimed disclosure.

With formidable challenges posed by global environmental change resulting from biodiversity loss, climate change, and plastics pollution, societies face increasing pressure to eliminate the negative impacts of their activities. In response, a majority of nations, corporations, universities, and other organizations have pledged to achieve net-zero emissions of flows such as greenhouse gases and plastics within a few decades. These pledges represent a promising sign of progress toward a sustainable future; however, fulfilling them in a manner that is economically feasible, socially desirable, and ecologically viable presents many difficulties.

Fields to which this approach pertains include engineering disciplines that involve processes for manufacturing various types of chemical or material products. These include various types of plastics, solvents, chemical intermediates, fertilizers, iron and steel, aluminum, cement, semiconductor materials, and more. Related fields also relate to electricity, heat, and fuel generation technologies from both renewable and nonrenewable resources.

### SUMMARY

In general, this disclosure addresses systems, methods, and apparatuses for implementing a net-zero emission and resource efficient roadmap development tool.

Achieving net-zero emissions pledges is a complex task that may require systematic models, methods, and tools, such as those described herein. Aspects of the disclosure describe techniques for systems optimization, systems engineering, sustainable engineering, and methods for life cycle assessment and circular economy.

For instance, described techniques enable industry to navigate its transition to a future with net-zero emissions of greenhouse gases, plastics, and other pollutants. Aspects of the disclosure include methods implemented by a configurable software tool that may utilize data from various sources to assess the life cycle environmental impacts and techno-economic aspects of current and future technologies, while suggesting a roadmap to guide the transition toward meeting specified goals and target dates. For instance, such an approach may calculate various metrics such as carbon footprint, circularity index, network resilience, and cost to compare specific scenarios, ranging from business-as-usual to the adoption of a variety of short- and long-term emerging technologies. Continuing with such an example, trade-offs between objectives may be evaluated through multi-objective optimization methods, enabling selective configuration and experimentation. Hotspot analysis and sensitivity optimization may be optionally utilized. The described technique may also model the evolution of emerging technologies over time, accounting for uncertainties, and incorporating changes in climate and other factors. According to at least one example, the described technique provides, as output, a roadmap specifying milestones for transitioning to new technologies, associated costs, and their effect on environmental impacts.

The described approach enables corporations and other organizations to navigate their transformation to net-zero emissions while managing costs and other impacts. For instance, aspects of the described technique enables organizations to identify hotspots of high environmental impacts and to pinpoint current and emerging technologies that are most promising for achieving net-zero emissions at the lowest cost.

Users of a net-zero emission and resource efficient roadmap development tool implemented and configured utilizing the described techniques may evaluate and compare a large number of scenarios that involve combinations of alternatives among energy types and sources, raw materials, end-of-life options, carbon capture and utilization, and others. In one example, users of such a tool may rank-order alternatives in terms of their potential to guide subsequent research and development activities. The tool may facilitate the development and generation of a roadmap that accounts for changes in technology readiness levels, climate, and societal aspects such as demand, preferences, and costs. The tool may also facilitate identification of technologies that are most resilient to future uncertainties.

Aspects of the disclosure utilize advanced methods for sustainable engineering, including life cycle assessment, circularity assessment, optimization methods, uncertainty analysis, and integrated assessment. The described approach may be used to evaluate and create roadmaps for systems of various types and scales based on information about relevant products and processes, including globally, specific regions, nations, or corporations.

Individual products may also be evaluated, with the most promising technologies being identified, with developed roadmaps generated for adaptively managing the transition to net-zero emissions utilizing data from a diverse array of sources, including public domain sources, proprietary databases, and industry-specific data.

In at least one example, processing circuitry is configured to perform a method of using an artificial neural network (ANN) to generate a transition roadmap for net-zero emissions and circularity is described. In one example, the method includes obtaining one or more datasets quantifying a circularity threshold and a life-cycle environmental impact threshold over a configurable time horizon for the transition roadmap. According to certain examples, the method includes obtaining quantified technology readiness levels (TRLs) for a plurality of transition technologies. In at least one example, the method includes training, by a computer, the ANN based on the one or more datasets and a selected training algorithm, to generate a trained ANN. According to such examples, the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies. In one example, the method includes determining, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap. According to certain examples, the method includes outputting the transition roadmap specifying the subset of the transition technologies relative to the configurable time horizon.

In at least one example, a system is described comprising processing circuitry and non-transitory computer-readable media configured to use an artificial neural network (ANN) to generate a transition roadmap for net-zero emissions and circularity. In one example, the system includes instructions that, when executed by the processing circuitry, configure the processing circuitry to obtain one or more datasets quantifying a circularity threshold and a life-cycle environmental impact threshold over a configurable time horizon for the transition roadmap. According to certain examples, the system includes instructions to obtain quantified technology readiness levels (TRLs) for a plurality of transition technologies. In at least one example, the system includes instructions to train the ANN based on the one or more datasets and a selected training algorithm, to generate a trained ANN. According to such examples, the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies. In one example, the system includes instructions to determine, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap. According to certain examples, the system includes instructions to output the transition roadmap specifying the subset of the transition technologies relative to the configurable time horizon.

In one example, non-transitory computer-readable media are described having instructions that, when executed, configure processing circuitry to perform specific tasks. In one example, the instructions configure the processing circuitry to obtain one or more datasets quantifying a circularity threshold and a life-cycle environmental impact threshold over a configurable time horizon for the transition roadmap. According to certain examples, the instructions configure the processing circuitry to obtain quantified technology readiness levels (TRLs) for a plurality of transition technologies. In at least one example, the instructions configure the processing circuitry to train an artificial neural network (ANN) to generate a transition roadmap for net-zero emissions and circularity based on the one or more datasets and a selected training algorithm. According to such examples, the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies. In one example, the instructions configure the processing circuitry to determine, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap. According to certain examples, the instructions configure the processing circuitry to output the transition roadmap specifying the subset of the transition technologies relative to the configurable time horizon.

According to another example, a device is described which includes means for obtaining one or more datasets quantifying a circularity threshold and a life-cycle environmental impact threshold over a configurable time horizon for the transition roadmap. The device also includes means for obtaining quantified technology readiness levels (TRLs) for a plurality of transition technologies. Furthermore, the device includes means for training, by a computer, an artificial neural network (ANN) based on the one or more datasets and a selected training algorithm to generate a trained ANN. The selected training algorithm includes an evolution function applied to the plurality of transition technologies using the quantified TRLs and a trade-off function to predict whether the circularity threshold or the life-cycle environmental impact threshold are satisfied at varying evolution points of the transition technologies. Additionally, the device includes means for determining, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap. Finally, the device includes means for outputting the transition roadmap specifying the subset of the transition technologies relative to the configurable time horizon.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 depicts workflow to generate roadmaps, illustrating a workflow to efficiently integrate design of conventional and innovative value-chains for generating roadmaps to meet environmental targets toward sustainable circular economies, in accordance with aspects of this disclosure.

FIG. 3 provides a summary of a multiperiod planning function provided by a net-zero framework utilized to roadmap innovations for meeting net-zero emissions and circularity targets, in accordance with aspects of this disclosure.

FIG. 4A depicts an innovative Pareto-fronts graph, providing multiple Pareto-fronts for available innovations as illustrative examples, in accordance with aspects of this disclosure.

FIG. 4B depicts example value-chain solutions, illustrating alternative material flow network configurations corresponding to selected points on Pareto-optimal solutions (see FIG. 4A), in accordance with aspects of this disclosure.

FIG. 5 depicts an emission intensity graph, illustrating emission intensity from electricity generation projected for the United States in the future considering a middle-of-the-road shared socioeconomic pathway (SSP2) scenario, in accordance with aspects of this disclosure.

FIG. 6 depicts a stochastic technology forecasting graph, illustrating simulated continuous-time Markov chains for innovations available in case studies, based on each corresponding sector, in accordance with aspects of this disclosure.

FIG. 7 depicts results for a shared socioeconomic pathway (SSP2) scenario, in accordance with aspects of the disclosure.

FIG. 8A depicts a greenhouse gas (GHG) emissions profile graph, illustrating GHG emissions over time for the proposed optimal roadmap under the shared socioeconomic pathway SSP2 representative concentration pathway (RCP) 3.4 scenario, in accordance with aspects of this disclosure.

FIG. 8B depicts a circularity profile graph, illustrating the evolution of value-chain circularity over time for the proposed optimal roadmap under the SSP2 RCP 3.4 scenario, in accordance with aspects of this disclosure.

FIG. 8C depicts a cost objective graph, illustrating operating costs associated with selected value-chain configurations over time for the proposed optimal roadmap under the SSP2 RCP 3.4 scenario, in accordance with aspects of this disclosure.

FIG. 9A depicts a baseline scenario greenhouse gas (GHG) emissions graph, illustrating GHG emissions profiles for the optimal roadmap under the baseline climate scenario within the shared socioeconomic pathway (SSP2), in accordance with aspects of this disclosure.

FIG. 9B depicts a RCP 6.0 scenario GHG emissions graph, illustrating GHG emissions profiles for the optimal roadmap under the representative concentration pathway (RCP) 6.0 scenario within SSP2, in accordance with aspects of this disclosure.

FIG. 9C depicts a RCP 4.5 scenario GHG emissions graph, illustrating GHG emissions profiles for the optimal roadmap under the RCP 4.5 scenario within SSP2, in accordance with aspects of this disclosure.

FIG. 9D depicts a RCP 3.4 scenario GHG emissions graph, illustrating GHG emissions profiles for the optimal roadmap under the RCP 3.4 scenario within SSP2, in accordance with aspects of this disclosure.

FIG. 9E depicts a RCP 2.6 scenario GHG emissions graph, illustrating GHG emissions profiles for the optimal roadmap under the RCP 2.6 scenario within SSP2, in accordance with aspects of this disclosure.

FIG. 10 depicts a cost objective comparison graph, illustrating the relationship between climate change scenarios and the corresponding total cost objectives for the grocery bags value-chain, in accordance with aspects of this disclosure.

FIG. 11 is a flow diagram illustrating an example method for using an artificial neural network (ANN) to generate a transition roadmap for net-zero emissions and circularity, in accordance with aspects of this disclosure.

Like reference characters denote like elements throughout the text and figures.

### DETAILED DESCRIPTION

In general, this disclosure addresses systems, methods, and apparatuses for implementing a net-zero emission and resource efficient roadmap development tool.

Achieving net-zero emissions pledges is a complex task that may require systematic models, methods, and tools, such as those described herein. Aspects of the disclosure describe techniques for systems optimization, systems engineering, sustainable engineering, and methods for life cycle assessment and circular economy.

For instance, described techniques enable industry to navigate its transition to a future with net-zero emissions of greenhouse gases, plastics, and other pollutants. Aspects of the disclosure include methods implemented by a configurable software tool that may utilize data from various sources to assess the life cycle environmental impacts and techno-economic aspects of current and future technologies, while suggesting a roadmap to guide the transition toward meeting specified goals and target dates. For instance, such an approach may calculate various metrics such as carbon footprint, circularity index, network resilience, and cost to compare specific scenarios, ranging from business-as-usual to the adoption of a variety of short- and long-term emerging technologies. Continuing with such an example, trade-offs between objectives may be evaluated through multi-objective optimization methods, enabling selective configuration and experimentation. Hotspot analysis and sensitivity optimization may be optionally utilized. The described technique may also model the evolution of emerging technologies over time, accounting for uncertainties, and incorporating changes in climate and other factors. According to at least one example, the described technique provides, as output, a roadmap specifying milestones for transitioning to new technologies, associated costs, and their effect on environmental impacts.

The described approach enables corporations and other organizations to navigate their transformation to net-zero emissions while managing costs and other impacts. For instance, aspects of the described technique enables organizations to identify hotspots of high environmental impacts and to pinpoint current and emerging technologies that are most promising for achieving net-zero emissions at the lowest cost.

Users of a net-zero emission and resource efficient roadmap development tool implemented and configured utilizing the described techniques may evaluate and compare a large number of scenarios that involve combinations of alternatives among energy types and sources, raw materials, end-of-life options, carbon capture and utilization, and others. In one example, users of such a tool may rank-order alternatives in terms of their potential to guide subsequent research and development activities. The tool may facilitate the development and generation of a roadmap that accounts for changes in technology readiness levels, climate, and societal aspects such as demand, preferences, and costs. The tool may also facilitate identification of technologies that are most resilient to future uncertainties.

Aspects of the disclosure utilize advanced methods for sustainable engineering, including life cycle assessment, circularity assessment, optimization methods, uncertainty analysis, and integrated assessment. The described approach may be used to evaluate and create roadmaps for systems of various types and scales based on information about relevant products and processes, including globally, specific regions, nations, or corporations. Individual products may also be evaluated, with the most promising technologies being identified, with developed roadmaps generated for adaptively managing the transition to net-zero emissions utilizing data from a diverse array of sources, including public domain sources, proprietary databases, and industry-specific data.

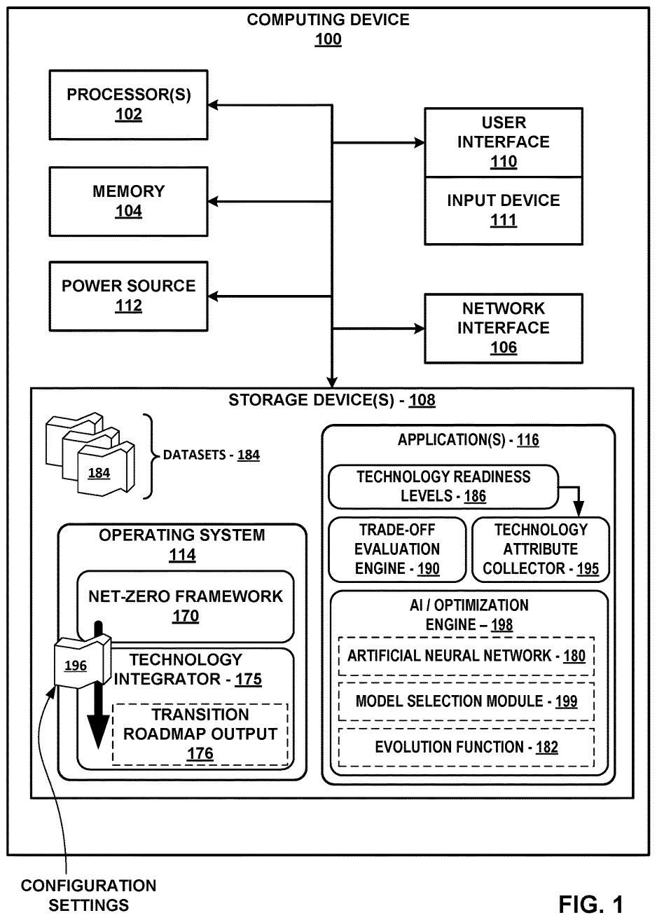

FIG. 1 is a block diagram illustrating further details of one example of computing device 100, in accordance with aspects of this disclosure.

FIG. 1 illustrates one particular example of computing device 100. Many other examples of computing device 100 may be used in other instances.

As shown in FIG. 1, computing device 100 includes processor(s) 102, memory 104, network interface 106, storage device(s) 108, user interface 110, and power source 112. Computing device 100 also includes operating system 114. Computing device 100, in one example, further includes application(s) 116, including trade-off evaluation engine 190 and technology attribute collector 195, which are responsible for aggregating various characteristics, attributes, and quantitative and qualitative aspects of technologies. These aspects may include implementation costs, grid compatibility, societal demand, climate impact, and policy constraints.

Additionally, artificial intelligence (AI)/optimization engine 198, within application(s) 116, executes predictive operations utilizing artificial neural network 180, optimization-based methodologies, or hybrid techniques based on selection made by model selection module 199. Model selection module 199 determines suitable computational approaches depending on configuration settings 196, ensuring tailored evaluation of sustainability pathways. Configuration settings 196 feed into net-zero framework 170, which in turn outputs to transition roadmap output 176. For instance, suitability may be based on quantitative confidence thresholds or other computed or predicted values which serve as basis for comparison. AI/optimization engine 198 includes artificial neural network 180, which provides predictive modeling capabilities based on artificial neural networks (ANNs), and evolution function 182, which is applied to transition technologies using quantified technology readiness levels (TRLs) to model technology progression over time. Datasets 184, stored within storage device(s) 108, provide input datasets used by artificial neural network 180 and other components of net-zero framework 170. Technology readiness levels 186, within application(s) 116, outputs to technology attribute collector 195 to supply quantified TRL values for transition technologies, enabling technology attribute collector 195 and technology integrator 175 to assess readiness for commercialization and feasibility of integration.

Operating system 114 executes various functions of net-zero framework 170 in conjunction with trade-off evaluation engine 190, technology attribute collector 195, and AI/optimization engine 198. Trade-off evaluation engine 190 quantifies results of competing sustainability strategies, and technology attribute collector 195 provides structured inputs regarding TRLs, economic feasibility, and emissions impact.

Trade-off evaluation engine 190 may also prioritize areas in need of further development and technical refinement using sensitivity optimization. In such examples, trade-off evaluation engine 190 may identify specific model parameters and sectors where optimal perturbations yield significant improvements to SCE objectives. Processor(s) 102 may utilize these sensitivity results to rank technology gaps, thereby providing a structured basis for directing research and development activities within transition roadmap output 176.

AI/optimization engine 198 executes either ANN-driven predictive modeling or structured mathematical optimization. When ANN-based methods are used, AI/optimization engine 198 processes data from technology attribute collector 195, applies machine learning algorithms, and refines transition roadmap output 176 through iterative learning techniques. Artificial neural network 180 operates within AI/optimization engine 198 to generate predictions from structured datasets, applying evolution function 182 to model evolution of transition technologies using TRL values supplied by technology readiness levels 186. Alternatively, when optimization-based approaches are selected, AI/optimization engine 198 applies linear programming, mixed-integer programming, or evolutionary algorithms to systematically determine optimal transition strategies.

When ANN-based modeling is selected by model selection module 199, artificial neural network 180 may be trained using a selected training algorithm that incorporates evolution function 182 and a trade-off function executed by trade-off evaluation engine 190 as components of its learning logic. In such examples, CTMC simulations performed in advance by stochastic model 336 generate TRL evolution profiles for each transition technology, and these profiles serve as structured training data supplied to artificial neural network 180 via technology attribute collector 195. Evolution function 182 operates within the selected training algorithm to encode the expected progression of each transition technology across varying TRL states, enabling artificial neural network 180 to learn the relationship between TRL evolution points and readiness for adoption. Trade-off evaluation engine 190 supplies the trade-off function, which operates within the selected training algorithm to evaluate whether circularity and life-cycle environmental impact thresholds are satisfied at each evolution point encountered during training. Artificial neural network 180 may be configured with one or more hidden layers and trained using a loss function that penalizes predictions inconsistent with both the circularity threshold and the life-cycle environmental impact threshold across the configurable time horizon. Multi-objective optimization outputs, including Pareto-optimal value-chain configurations generated by net-zero framework 170, may serve as labeled training examples against which artificial neural network 180 refines its internal weights through iterative learning.

Model selection module 199 determines which approach (ANNs, optimization, or hybrid) is most appropriate based on configuration settings 196, ensuring that effective computational strategy is applied based on available data, problem constraints, and user-defined objectives.

Net-zero framework 170 enables users to explore scenarios involving combinations of energy sources (renewable, nonrenewable, heat, electricity), end-of-life processes (landfilling, mechanical and chemical recycling), raw materials (fossil, biomass), and carbon management (capture, utilization, storage). These evaluations, performed by AI/optimization engine 198, leverage both ANN-based simulations and optimization-driven decision-making to provide robust, scalable approaches to net-zero planning.

Scenarios may include technologies at various readiness levels, from commercially available solutions to laboratory-scale innovations. Technology attribute collector 195 provides data on TRLs received from technology readiness levels 186, ensuring that transition roadmap output 176 reflects realistic adoption timelines. Net-zero framework 170 can also identify hotspots, pinpointing areas where research and development should be focused.

Through integration of model selection module 199, AI/optimization engine 198, and trade-off evaluation engine 190, net-zero framework 170 provides holistic approaches to sustainability planning, balancing economic feasibility, emissions impact, and circularity metrics using both ANN-driven learning and structured mathematical optimization.

Prior known techniques for guiding decisions toward sustainability focus primarily on life cycle assessment (LCA). While LCA is helpful for comparing alternatives, it does not directly guide transitions to net-zero emissions. Emerging startups, such as Carbon Minds and Sesame Sustainability, attempt to address this gap, but net-zero framework 170, powered by AI/optimization engine 198, provides more advanced and theoretically rigorous approaches.

Unlike traditional approaches, net-zero framework 170 offers multi-objective, AI-driven systems that evaluate scenarios, identify hotspots, and develop optimized roadmaps. Computing device 100 can integrate publicly available databases, proprietary industry data, or commercial datasets including those stored as datasets 184, providing flexible and comprehensive sustainability transition tools. Net-zero framework 170 may also be configured to utilize models derived from fundamental knowledge of chemistry and processing. In such examples, AI/optimization engine 198 incorporates deterministic process models grounded in chemical principles and thermodynamic relationships, enabling processor(s) 102 to generate transition roadmap output 176 that reflects physically plausible pathways for chemical and material industry transitions. This capability allows net-zero framework 170 to evaluate value-chain configurations using both data-driven inputs and first-principles process modeling, depending on the availability and nature of user-supplied or default data within datasets 184.

Net-zero framework 170 provides a technical improvement to computer-implemented processing of high-dimensional, time-varying sustainability data that prior computational approaches could not practically achieve. Specifically, net-zero framework 170 integrates CTMC-based stochastic simulation, multi-period mixed-integer optimization, and ANN-based predictive modeling within a unified computational architecture executed by processor(s) 102. This integration reduces the computational complexity associated with evaluating combinatorially large sets of value-chain configurations across multi-decade time horizons by enabling AI/optimization engine 198 to selectively apply ANN-based inference, optimization-based solvers, or hybrid approaches via model selection module 199, depending on the structure and dimensionality of the problem encountered. The piecewise linear surrogate representations of CTMC evolution profiles, generated in advance and incorporated into multiperiod planning function 300, further reduce computational load during optimization by replacing nonlinear stochastic expressions with tractable linear approximations that processor(s) 102 can evaluate efficiently within each time period. These computational techniques, operating together within net-zero framework 170, enable processor(s) 102 to generate transition roadmap output 176 across problem scales and time horizons that would require prohibitive computation under conventional approaches, representing a specific improvement to the technical operation of computing device 100 rather than a generic application of computing to an organizational task.

Advanced optimization and graphical visualization techniques allow users to interactively explore trade-offs between economic and environmental impacts. Net-zero framework 170 supports net-zero hackathons and university courses, making it a valuable tool for both academic and professional use. AI/optimization engine 198 ensures that scenario exploration remains computationally efficient, scalable, and adaptable to evolving policies and market conditions.

Trade-off evaluation engine 190 may generate interactive visualizations of Pareto surfaces obtained from multi-objective optimization. User interface 110 may display these Pareto surfaces to enable users to interactively traverse the objective space defined by cost, carbon footprint, and circularity metrics. By manipulating the visualization through input device 111, users may identify combinations of innovations and gain insight into how specific technological shifts influence the Pareto-optimal frontier, thereby supporting investment and research and development prioritization decisions.

Moreover, net-zero framework 170 is compatible with spatial modeling extensions and advanced sustainability assessment methodologies, positioning it as flexible and expandable for sustainability planning.

In some examples, processing circuitry including processor(s) 102 implements functionality and/or process instructions for execution within computing device 100. For example, processor(s) 102 may be capable of processing instructions stored in memory 104 and/or instructions stored on storage device(s) 108.

Memory 104, in one example, may store information within computing device 100 during operation. Memory 104, in some examples, may represent computer-readable storage media. In some examples, memory 104 may be temporary memory, meaning that primary purpose of memory 104 may not be long-term storage. Memory 104, in some examples, may be described as volatile memory, meaning that memory 104 may not maintain stored contents when computing device 100 is turned off. Examples of volatile memories may include random access memory (RAM), dynamic random-access memory (DRAM), static random-access memory (SRAM), and other forms of volatile memories. In some examples, memory 104 may be used to store program instructions for execution by processor(s) 102. Memory 104, in one example, may be used by software or applications running on computing device 100 (e.g., application(s) 116) to temporarily store data and/or instructions during program execution.

Storage device(s) 108, in some examples, may also include one or more computer-readable storage media. Storage device(s) 108 may be configured to store larger amounts of information than memory 104. Storage device(s) 108 may further be configured for long-term storage of information. In some examples, storage device(s) 108 may include non-volatile storage elements. Examples of such non-volatile storage elements may include magnetic hard disks, optical discs, floppy disks, flash memories, or forms of electrically programmable memory (EPROM) or electrically erasable and programmable memory (EEPROM). Datasets 184 may reside within storage device(s) 108 and may be accessed by artificial neural network 180 and other components of net-zero framework 170 during operation.

Computing device 100, in some examples, may also include network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that can send and receive information. Other examples of such network interfaces may include BLUETOOTH, 3G, 4G, 1G, LTE, and WI-FI radios in mobile computing devices as well as universal serial bus (USB). In some examples, computing device 100 may use network interface 106 to wirelessly communicate with external devices such as servers, mobile phones, or other networked computing devices.

Computing device 100 may also include user interface 110. User interface 110 may include input device 111, such as a touch-sensitive display. Input device 111, in some examples, may be configured to receive input from users through tactile, electromagnetic, audio, and/or video feedback. Examples of input device 111 may include touch-sensitive displays, mice, keyboards, voice responsive systems, video cameras, microphones or any other type of device for detecting gestures by users. In some examples, touch-sensitive displays may include presence-sensitive screens.

User interface 110 may also include one or more output devices, such as display screens of computing devices or touch-sensitive displays, including touch-sensitive displays of mobile computing devices. Output devices, in some examples, may be configured to provide output to users using tactile, audio, or video stimuli. Output devices, in one example, may include displays, sound cards, video graphics adapter cards, or any other type of device for converting signals into appropriate forms understandable to humans or machines. Additional examples of output devices may include speakers, cathode ray tube (CRT) monitors, liquid crystal displays (LCD), or any other type of device that can generate intelligible output to users.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in storage device(s) 108 and may control operation of components of computing device 100. For example, operating system 114 may facilitate interaction of application(s) 116 with hardware components of computing device 100.

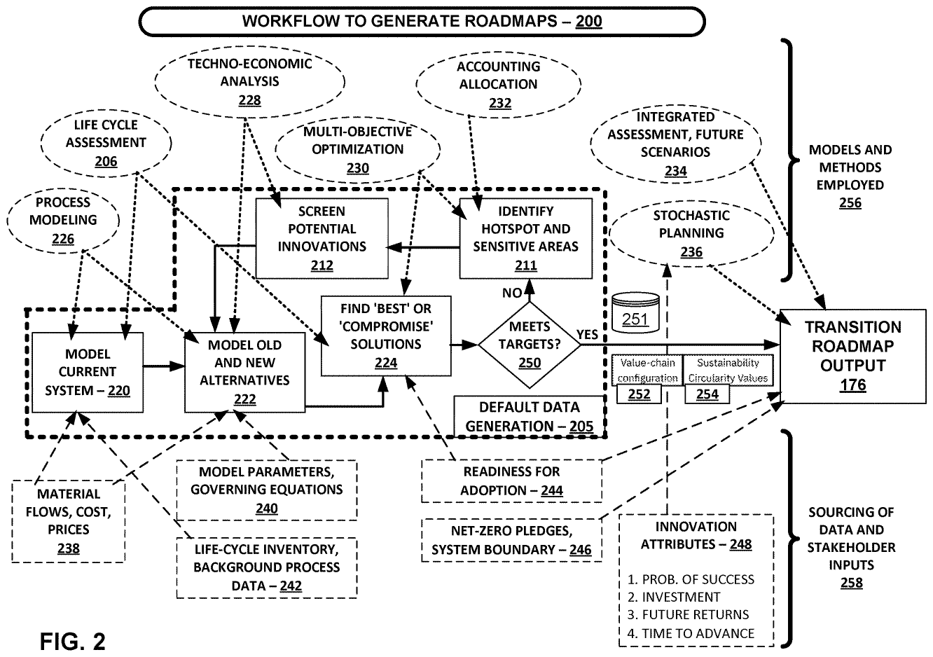

FIG. 2 depicts workflow to generate roadmaps 200, illustrating a workflow to efficiently integrate design of conventional and innovative value-chains for generating roadmaps to meet environmental targets toward sustainable circular economies, in accordance with aspects of this disclosure.

Workflow to generate roadmaps 200 organizes the overall process by which net-zero framework 170 (see FIG. 1) receives inputs, processes alternatives, evaluates targets, and produces transition roadmap output 176. Workflow to generate roadmaps 200 is divided into two contextual regions: models and methods employed 256, which identifies the analytical and computational approaches used at each stage, and sourcing of data and stakeholder inputs 258, which identifies the external data and input sources that feed into workflow to generate roadmaps 200. Data corresponding to innovative value-chain solutions can be generated from existing models to design Pareto-optimal life-cycle networks, or may be obtained directly from users as configuration settings 196 or specified data inputs.

Increasing impact of human activities on Earth's ecosystem goods and services has brought humanity into new geological epochs, referred to as the Anthropocene. If trends of ecological degradation caused by natural resource exploitation and environmental pollution continue, Earth may exceed tipping points for environmental sustainability and exit the safe-operating-space for human well-being. To avoid and mitigate these adverse outcomes, global communities use new technologies, policies, and supply chains to enable sustainability transitions toward economies characterized by net-zero emissions and waste recycling. Therefore, modeling and optimizing implementation of sustainability transitions has become a growing area of interest in academia, policymaking, and corporate research and development.

Several organizations have pledged to achieve net-zero emissions and high sustainable content in products as early as 2030. These include carbon neutrality targets set by governments under the Paris Accord; organizational net-zero emission targets for 2030 (by Apple, Alphabet, Microsoft, Walgreens, Kroger, etc.), 2040 (by Walmart, Amazon, Target, Intel, FedEx, PepsiCo, etc.), and 2050 (by ExxonMobil, BP, Dow Chemical, Mitsubishi, etc.); circularity targets set by signatories of the Plastics Pact; and various campus sustainability goals. Actions and interventions toward achieving these net-zero emissions and circularity targets present rare opportunities not only to achieve environmental sustainability but also to promote ecosystem restoration, protection, and address social inequities. If executed properly, these efforts can provide companies with benefits of market leadership through innovation while addressing existential threats.

Meeting these challenges may benefit from adoption of trans-disciplinary or convergent systems approaches to guide future developments, including approaches for creating integrated value-chain and supply-chain networks. This highlights a need for evaluating performance of each organization from holistic perspectives, and for creating tools that enable transitions and build transition roadmap output 176 toward achieving these targets. Despite ambiguity surrounding reporting mechanisms and system boundaries for many of these targets, several standards and initiatives, such as the Science-Based Targets Initiative, the Task Force for Climate-related Financial Disclosures, and the International Sustainability and Carbon Certification, are being developed and implemented.

The current state of the art lacks frameworks through which such transitions may be holistically guided and through which to systematically identify developed roadmaps for investing in novel technologies and partnerships. Much of current research focuses on building localized models for specific use cases, such as displacement of vendors in supply-chain networks or how changes affect operational impact for given companies or influence economic performance of such companies. Prior theoretical frameworks borrowed concepts from evolutionary economics, sociology, and institutional dynamics, examples of which include the Transition Management framework, the Multi-Level Perspective, the Strategic Niche Management framework, and others. These sophisticated methods study substitution dynamics and reorientation trajectories of innovative product systems. However, these focus on adoption of isolated innovations, often overlooking synergistic effects and implications for environmental impact of entire systems. Prior known techniques do not permit selection and planning of innovations based on holistic environmental impact and potential synergies with conventional systems currently in place and other innovations being proposed. In the operations management and ecological economics domains, portfolio management approaches to predict odds of technology adoption are commonly described based on heuristics and market indicators, and often lack holistic environmental impact assessment necessary for prioritizing investments. Other techniques propose evaluating novel technologies and product systems in futuristic contexts with marginal supply mixes of electricity, while calculating holistic environmental impacts using consequential life cycle assessment (LCA) approaches. However, such techniques do not support inclusion of multiple alternatives and do not perform planning to generate temporal roadmaps for future use. No known solution provides systemic frameworks for guiding and planning adoption of novel solutions to meet ambitious targets aimed at combating climate change and pollution. More particularly, prior known solutions do not enable creation of developed transition plans which account for climate change phenomena, such as evolving energy mixes and policy toward decarbonization. Conversely, net-zero framework 170 applies technology attribute collector 195 to leverage integrated assessment models (IAMs), which characterize global environmental change through quantification of interactions between human and earth systems.

IAMs are computational tools that analyze complex interactions between human and Earth systems to understand global environmental changes. By incorporating both natural processes and human activities, IAMs quantify impact of various factors, such as greenhouse gas (GHG) emissions, policy interventions, and technological advancements, on climate change and other environmental outcomes. Once quantified, IAM models enable technology attribute collector 195 to evaluate potential future scenarios and make decisions on strategies for mitigating environmental risks, adapting to climate change, and achieving sustainability goals according to configuration settings 196 and other parameters.

Artificial neural networks (ANNs) and optimization-based methods represent two distinct but complementary computational approaches for decision-making and predictive modeling in sustainability transitions. ANNs are machine learning models inspired by the structure and function of the human brain, composed of layers of interconnected nodes (neurons) that process information through weighted connections. These models excel at recognizing complex patterns in large datasets, making them well-suited for tasks such as forecasting, classification, and anomaly detection in environmental and industrial contexts. Within net-zero framework 170, ANN models may be executed via artificial intelligence (AI) /optimization engine 198, which is configurable to process decision-making models and generate predictions from structured datasets. AI/optimization engine 198 includes model selection module 199, which determines whether to apply ANN-based modeling, optimization-based modeling, or hybrid approaches, based on configuration settings 196. Technology attribute collector 195 gathers relevant data, and trade-off evaluation engine 190 preprocesses data to extract features necessary for ANN-based modeling. Once trained, ANNs may be applied to generate transition roadmaps by learning from historical data and simulating probable evolution of technology adoption, emissions trends, and policy impacts.

Alternatively, optimization-based methods may be employed instead of ANNs, depending on the scenario. Optimization problems involve selecting decision variables from defined sets of alternatives to minimize or maximize objective functions while adhering to specific constraints. The structured nature of optimization problems allows for direct formulation and systematic evaluation of multiple decision pathways based on sustainability criteria, such as GHG emissions reduction, circularity targets, and cost efficiency. Unlike ANNs, which rely on training data and may not inherently respect strict feasibility constraints, optimization methods provide interpretable, constraint-satisfying solutions that guide investment and policy decisions with higher transparency. AI/optimization engine 198 executes mathematical programming solvers, such as linear programming, mixed-integer programming, or evolutionary algorithms, to systematically determine transition strategies. Model selection module 199 ensures that AI/optimization engine 198 dynamically selects appropriate computational methods. These solvers interact with technology integrator 175, ensuring that generated transition roadmap output 176 aligns with defined sustainability objectives.

Optimization-based techniques enable systematic identification of Pareto-optimal trade-offs between competing objectives, ensuring that generated transition roadmap output 176 balances cost, environmental impact, and technological feasibility over time. Additionally, optimization provides time-dependent decision-making capabilities, accommodating evolving technology readiness levels (TRLs), policy landscapes, and regulatory frameworks dynamically. While ANN-based approaches offer valuable insights by learning from historical data, they are highly data-driven, and optimization-based techniques may be preferable in scenarios where structured constraints and explicit decision logic are to be modeled. Therefore, net-zero framework 170, via AI/optimization engine 198, applies either ANN methodologies, optimization-based methodologies, or hybrid approaches, depending on configuration settings 196. Model selection module 199 facilitates this flexibility, ensuring that sustainability transitions are not only data-informed but also systematically planned, taking into account technological uncertainties, economic constraints, and evolving policy requirements.

In such ways, net-zero framework 170 enables road-mapping tools to systematically generate and output sustainable circular economies utilizing concepts from process systems engineering, such as superstructure optimization and multi-period planning, to identify optimal transition strategies to meet environmental targets. In some examples, net-zero framework 170 is configurable to generate transition roadmap output 176 based on selection of innovative value-chain solutions at different time periods to consistently meet consumer demand while achieving overall targets for life-cycle environmental emissions in future operations.

Net-zero framework 170 may be configurable to generate transition roadmap output 176 solutions that minimize investment costs by capturing evolution of TRLs in the future through stochastic processes. TRLs represent systems for measuring and quantifying maturity of technologies, ranging from early-stage concepts to fully developed, market-ready solutions. Scales typically range from TRL 1, where basic principles are observed, to TRL 9, where technologies are proven and ready for deployment in operational environments. Use of TRLs enables technology integrator 175 to systematically and quantifiably assess potential risks and opportunities associated with new technologies, guiding decisions on investments and development strategies. By tracking progression of technologies through these levels, technology integrator 175 can estimate timing, scope, and scale that such technologies may be represented within transition roadmap output 176 based on readiness for commercialization and feasibility of integration into existing systems, according to TRL assessment for such technologies.

Net-zero framework 170 may also enable setting of carbon caps or taxation to ensure that generated solutions do not emit unfavorably in durations leading to targets being met. Total life-cycle emissions change along time horizons due to upstream decarbonization and climate change policy are accounted for using IAMs. Net-zero framework 170 may accept as input predictions from other models, which may then be utilized by net-zero framework 170 to generate customized transition roadmap output 176. Supplementary data from other models is optional. In other examples, users may specify proprietary datasets containing values of sustainability, circularity, and cost metrics for each innovation value-chain configuration for use by net-zero framework 170 when generating transition roadmap output 176.

In such ways, net-zero framework 170 provides general modeling frameworks to generate and explore transition roadmap output 176 relative to investment and adoption of innovations in any value-chain network to meet sustainability targets. For instance, net-zero framework 170 may be utilized to generate and explore realistic case studies involving development of sustainability transition roadmaps for introducing packaging innovations in grocery bags value-chain networks. In certain examples, net-zero framework 170 utilizes continuous-time Markov chains (CTMCs) to model technology evolution. CTMCs may be used to model technology evolution by representing transitions between different states of technology readiness over time. In such examples, technology integrator 175 evolves probabilistically, with likelihood of moving from one state to another depending on factors such as technological advancements, market conditions, and external influences as provided by technology attribute collector 195. The continuous-time aspect allows for modeling of changes occurring at any point in time, rather than in discrete intervals. This approach provides dynamic frameworks for forecasting evolution of TRLs, enabling decision-making by net-zero framework 170 regarding technology adoption, investment, and strategic planning.

Net-zero framework 170 creates strategies for investing in and adopting innovations and interventions within life-cycle networks of products provided as transition roadmap output 176. Transition roadmap output 176 selects environmental targets that meet both sustainability and circularity while satisfying configurable stakeholder objectives such as cost efficiency and cumulative life-cycle environmental impacts within selected time horizons. Configurable inputs may be provided using configuration settings 196 to specify, for example, emissions, circularity, and cost metrics for multiple value-chain configurations after introduction of each innovation. Resulting transition roadmap output 176 provides roadmaps or plans for investment and adoption of optimal innovations at various time points, based on sustainability targets, technology evolution, IAMs for climate change, and carbon taxation. By capturing dynamics of how technologies are likely to evolve in terms of readiness for adoption and imminent decarbonization of activities beyond stakeholder influences, transition roadmap output 176 indicates paths for transitioning toward net-zero emissions and circularity, guided by holistic perspectives.

Workflow to generate roadmaps 200 begins at model current system 220, which receives input from material flows, cost, prices 238 and life-cycle inventory, background process data 242, as well as model parameters, governing equations 240. Model current system 220 outputs to model old and new alternatives 222. Model old and new alternatives 222 receives additional input from model parameters, governing equations 240 and life-cycle inventory, background process data 242, and feeds into both screen potential innovations 212 and find ‘best’ or ‘compromise’ solutions 224.

Life cycle assessment 206 provides foundational analytical methods that feed into model current system 220 and model old and new alternatives 222. Process modeling 226 feeds into model current system 220 and model old and new alternatives 222. Techno-economic analysis 228 feeds into model old and new alternatives 222 and screen potential innovations 212. Multi-objective optimization 230 feeds into screen potential innovations 212 and find ‘best’ or ‘compromise’ solutions 224. Accounting allocation 232 feeds into find ‘best’ or ‘compromise’ solutions 224 and identify hotspot and sensitive areas 211. Integrated assessment, future scenarios 234 feeds into identify hotspot and sensitive areas 211 and transition roadmap output 176. Stochastic planning 236 feeds into transition roadmap output 176.

Screen potential innovations 212 and identify hotspot and sensitive areas 211 interact bidirectionally within the dashed-border screening loop. Identify hotspot and sensitive areas 211 outputs to find ‘best’ or ‘compromise’ solutions 224. Find ‘best’ or ‘compromise’ solutions 224 outputs to meets sustainability/circularity targets?250, which operates as a decision point in workflow to generate roadmaps 200. When the result of meets sustainability/circularity targets?250 is no, the workflow returns to identify hotspot and sensitive areas 211 for further screening. When the result is yes, the workflow proceeds to value-chain data store 251.

Upon a yes determination at meets sustainability/circularity targets?250, value-chain data store 251 supplies value-chain configuration 252 and sustainability circularity values 254, and outputs to transition roadmap output 176. Default data generation 205 provides consolidated data pathways that feed into find ‘best’ or ‘compromise’ solutions 224 and into data supply paths leading to transition roadmap output 176.

Sourcing of data and stakeholder inputs 258 encompasses several external input sources that feed into workflow to generate roadmaps 200. Readiness for adoption 244 supplies technology readiness information that feeds into workflow to generate roadmaps 200 toward default data generation 205 and transition roadmap output 176. Net-zero pledges, system boundary 246 provides system boundary definitions and organizational commitment parameters that feed into workflow to generate roadmaps 200. Innovation attributes 248 captures stakeholder-sourced parameters including probability of success, investment requirements, future returns, and time to advance, and feeds into workflow to generate roadmaps 200 toward transition roadmap output 176.

Users may follow default data generation 205, which provides strategy configurations and modeling inputs for net-zero framework 170 to generate transition roadmap output 176. Alternatively, users may custom specify input datasets, which include at least sustainability and circularity metrics for innovative value-chain configurations. Using workflow to generate roadmaps 200 results in development and generation of transition roadmap output 176 having informed roadmaps with systematically screened innovations and due consideration of trade-offs between circularity, GHG emissions, and costs.

Net-zero framework 170 is configured to design conventional value-chains by optimizing cradle-to-cradle life-cycle networks of consumer products. To reduce chance of proposed strategies shifting environmental burdens to other parts of value-chains, life cycle assessment 206 is used to quantify environmental impacts from entire life-cycles of current and emerging solutions, ranging from raw material extraction, manufacturing, processing, transport, usage, end-of-life, and recycling.

Net-zero framework 170 obtains Pareto fronts to quantify trade-offs between objectives such as sustainable circular economy (SCE), including circularity, global warming potential (GWP) of GHG emissions, and cost of natural resource use. Circularity is defined as the ratio of regenerated value through circular flows to the value of manufactured materials. Depending on the measure used for quantifying value, circularity can be defined in monetary or ecological terms. Alternatively, net-zero framework 170 can handle metrics for target-setting, such as material circularity indicators and circulytics as provided by the Ellen MacArthur Foundation, or circularity transition indicators as provided by the World Business Council for Sustainable Development, given a tabulation of unique values for circularity metrics for each value-chain configuration. GWP and natural resource use are calculated using life-cycle system boundaries and ReCiPe impact assessment factors to calculate GWP from value-chain emissions in kgCO₂ (carbon dioxide) equivalents. ReCiPe impact assessment factors are sets of metrics used in life-cycle assessments to evaluate environmental impact of products or processes, translating different types of environmental damage into common units, making it easier to compare environmental performance of different products or processes. The ReCiPe approach enables net-zero framework 170 to systematically differentiate between consequences of various possible actions and enable selection of more sustainable choices. Monetary circularity and GWP are utilized for target-setting in transition roadmap output 176. Such terms may be replaced by user-preferred definitions in input datasets.

Net-zero framework 170 is configured to operate identify hotspot and sensitive areas 211 by screening lists of new technologies, supply-chain strategies, policies, and other candidates, based on sectors that are emission hotspots and model parameters that can have optimal perturbations to improve SCE objectives.

Upon identifying one or more hotspot sectors or sensitive model parameters, net-zero framework 170 may generate an investment recommendation by processing the identified hotspots against innovation attributes 248 supplied through sourcing of data and stakeholder inputs 258. In such examples, technology attribute collector 195 retrieves, for each hotspot, corresponding innovation attributes 248 including probability of success, investment requirements, future returns, and time to advance. Trade-off evaluation engine 190 evaluates these attributes against the cost and emissions objectives of objective function 310 to rank candidate innovations according to their projected impact on SCE objectives relative to their associated investment requirements. Processor(s) 102 configures technology integrator 175 to incorporate these ranked candidates into transition roadmap output 176 as investment recommendations specifying which innovations correspond to identified hotspots, the estimated investment required to advance each innovation through its TRL states to commercialization, and the projected reduction in life-cycle environmental impact attributable to each investment. In this way, net-zero framework 170 converts technically identified emission hotspots into structured, prioritized investment recommendations that account for both financial and environmental parameters within the configurable time horizon.

Net-zero framework 170 is configured to operate screen potential innovations 212 by ranking selected alternatives and generating Pareto fronts corresponding to each alternative. Once selected subsets of innovations are included in life-cycle networks, net-zero framework 170 generates several Pareto fronts with each innovation or combination of innovations expected to show synergistic effects. Using Pareto fronts generated from holistic life-cycle design can develop roadmaps that account for entire life-cycles of products and innovations without shifting impact outside system boundaries. To create roadmaps for SCE, questions of when, where, and how to invest and adopt these innovations in value-chains are addressed by net-zero framework 170 through multi-period planning frameworks. Schematics for all processes involved in designing roadmaps for SCE and meeting environmental targets are demonstrated in workflow to generate roadmaps 200 as depicted in FIG. 2.

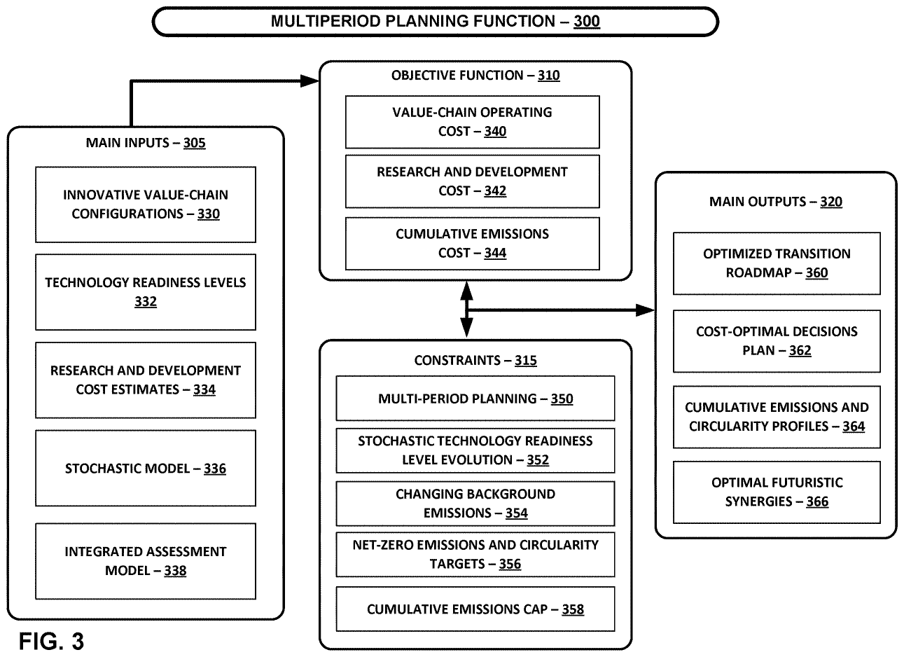

FIG. 3 provides a summary of multiperiod planning function 300 provided by net-zero framework 170 utilized to roadmap innovations for meeting net-zero emissions and circularity targets, in accordance with aspects of this disclosure.

Main inputs 305 outputs to objective function 310. Objective function 310 and constraints 315 interact bidirectionally. Objective function 310 outputs to main outputs 320.

Main inputs 305 includes multiple sets of objective values, such as life-cycle impact, greenhouse gas (GHG) emissions, circularity, and cost for each innovation, applied to one or more value-chain configurations. Such datasets may be obtained through default data generation 205 (see FIG. 2), specifically through multi-objective optimization of life-cycle networks. This can be achieved by using developed open-source frameworks to generate innovative Pareto fronts. Alternatively, data may be custom specified by users.

Main inputs 305 includes innovative value-chain configurations 330, technology readiness levels 332, research and development cost estimates 334, stochastic model 336, and integrated assessment model 338. Innovative value-chain configurations 330 includes objective function values such as life-cycle GHG emissions, cost of natural resource use, and circularity. Technology readiness levels 332 includes readiness values ranging from 1 to 10 for each innovation. Research and development cost estimates 334 represents estimates per unit technology readiness level (TRL) increase, expressed in United States dollars (USD) per ATRL. Stochastic model 336 predicts TRL evolution using continuous-time Markov chains (CTMCs) that include transition probabilities between TRL states and sojourn times in each TRL state. Because the decision variables of multiperiod planning function 300 do not influence CTMC transition probabilities or sojourn times under the assumptions applied herein, CTMC simulations may be performed in advance and represented as piecewise linear surrogate functions incorporated into multiperiod planning function 300. Integrated assessment model 338 provides decarbonization trajectories of power systems over time, utilizing representative concentration pathway (RCP) scenarios to compute time-dependent corrections to upstream GHG emissions from electricity generation.

Objective function 310 minimizes sums of value-chain operating cost 340, research and development cost 342, and cumulative emissions cost 344. Value-chain operating cost 340 includes the operating expense (OPEX) of resource use across selected value-chain configurations. Research and development cost 342 represents costs for investment in innovations, computed as proportional to the marginal difference between the expected readiness level of an innovation at the time of investment and the maximum readiness level corresponding to the diffusion stage, discounted to account for the time value of money. Cumulative emissions cost 344 represents costs of cumulative carbon dioxide (CO₂) emissions, which may be expressed as a carbon tax applied per unit of CO₂ equivalent emissions accrued over the time horizon.

Constraints 315 includes multi-period planning 350, stochastic technology readiness level evolution 352, changing background emissions 354, net-zero emissions and circularity targets 356, and cumulative emissions cap 358. Multi-period planning 350 governs when innovations may be invested in, when value-chain solutions become available for adoption, and how consumer demand may be distributed among selected solutions across time periods. Stochastic technology readiness level evolution 352 captures piecewise linear surrogate representations of CTMC-based TRL evolution profiles for use within the optimization. Changing background emissions 354 accounts for variations in upstream life-cycle emissions over time through integrated assessment model 338 representations. Net-zero emissions and circularity targets 356 implements terminal constraints requiring GHG emissions to reach net-zero and circularity to exceed a user-defined threshold by specified points in the time horizon. Cumulative emissions cap 358 bounds or penalizes total GHG emissions accrued throughout the time horizon to prevent excessive carbon budget consumption on the path to net-zero.

Main outputs 320 includes optimized transition roadmap 360, cost-optimal decisions plan 362, cumulative emissions and circularity profiles 364, and optimal futuristic synergies 366. Optimized transition roadmap 360 provides roadmaps to invest in innovations, adopt favorable value-chains, and distribute demand between favorable value-chains. Cost-optimal decisions plan 362 provides plans for cost-efficient investment and adoption decisions across the time horizon. Cumulative emissions and circularity profiles 364 provides time-series profiles tracking GHG emissions and circularity over time corresponding to the optimal roadmap. Optimal futuristic synergies 366 identifies combinations of innovations that perform robustly across multiple climate change scenarios and evolving climate action policies.

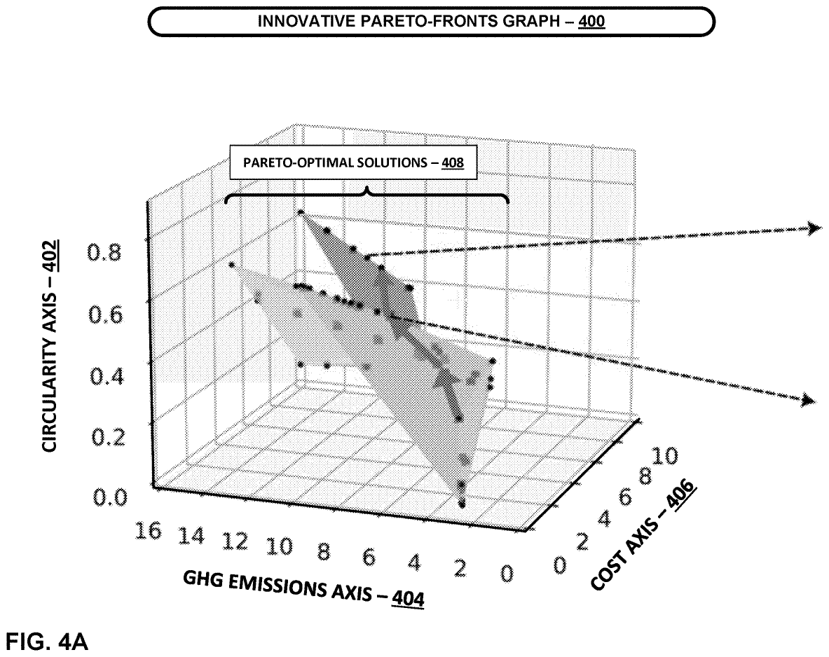

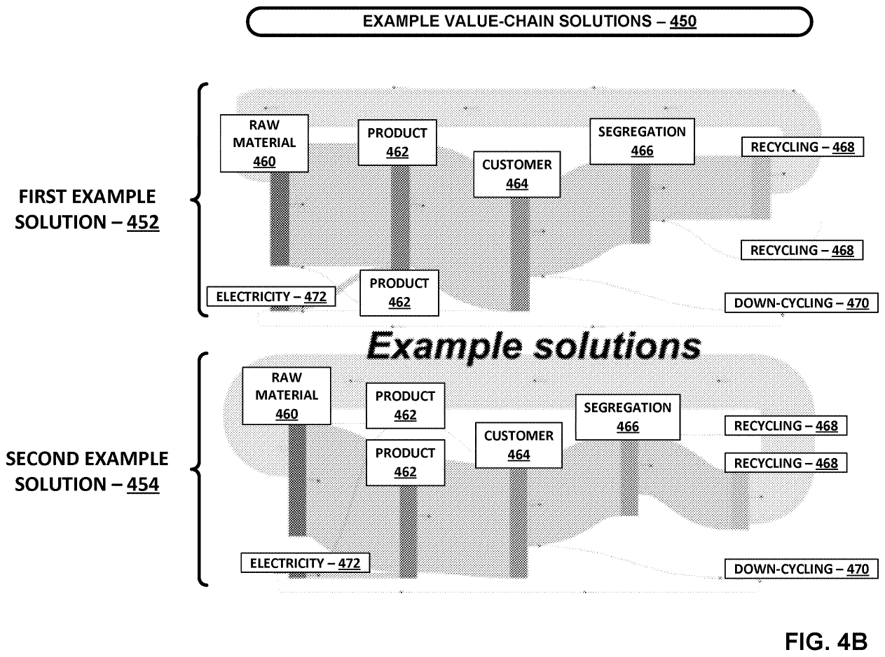

FIG. 4A depicts innovative Pareto-fronts graph 400, providing multiple Pareto-fronts for available innovations as illustrative examples, in accordance with aspects of this disclosure.

Innovative Pareto-fronts graph 400 presents three-dimensional objective spaces defined by circularity axis 402, greenhouse gas (GHG) emissions axis 404, and cost axis 406. GHG emissions are expressed in kgCO₂ equivalents on GHG emissions axis 404, and cost is estimated using price of natural resources in United States dollars (USD) on cost axis 406. Circularity axis 402 represents monetary regeneration factors as defined herein.

Pareto-optimal solutions 408 represent sets of compromise value-chain solutions for available innovations plotted within three-dimensional objective spaces of innovative Pareto-fronts graph 400. Each point within Pareto-optimal solutions 408 corresponds to value-chain solutions scaled to meet consumer demand. Each distinct Pareto-front within Pareto-optimal solutions 408 corresponds to distinct innovations or combinations of innovations. Multiperiod planning function 300 (see FIG. 3) provided by net-zero framework 170 (see FIG. 1) selects which innovations to invest in during each time period and determines how to distribute consumer demand among various compromise solutions represented within Pareto-optimal solutions 408.

Framework decisions made by net-zero framework 170 during each time period with respect to Pareto-optimal solutions 408 include the following. First, net-zero framework 170 determines whether to invest to activate given innovations, represented by binary variable yᵢ ∈{0,1}, where cost is a function of readiness level. Second, net-zero framework 170 traverses Pareto-optimal solutions 408 by selecting compromise solutions k on activated Pareto-sets Kᵢ, represented by yₖ ∈{0,1} when k is on activated Pareto-sets Kᵢ. Third, net-zero framework 170 distributes consumer demand among selected solutions, represented by xₖ ∈[0,1].

Traversal across Pareto-optimal solutions 408 represents progression of net-zero framework 170 from one innovative Pareto-front to another in objective domains across different time periods, as driven by multiperiod planning function 300. Dashed lines in innovative Pareto-fronts graph 400 indicate correspondence between selected points on Pareto-optimal solutions 408 and example value-chain solutions depicted in FIG. 4B.

FIG. 4B depicts example value-chain solutions 450, illustrating alternative material flow network configurations corresponding to selected points on Pareto-optimal solutions 408 (see FIG. 4A), in accordance with aspects of this disclosure.

Example value-chain solutions 450 includes first example solution 452 and second example solution 454. First example solution 452 and second example solution 454 each represent distinct value-chain configurations that may be selected by multiperiod planning function 300 to satisfy consumer demand during given time periods. Configurations differ in number and arrangement of product 462 stages and routing of material flows through value-chain networks.

Within first example solution 452 and second example solution 454, raw material 460 and electricity 472 feed into product 462. Product 462 outputs to customer 464. Customer 464 outputs to segregation 466. Segregation 466 outputs to recycling 468 and down-cycling 470. Recycling 468 feeds back into product 462, forming closed-loop circular flow networks. Down-cycling 470 represents end-of-life material flows that exit primary value-chain loops at reduced material value.

First example solution 452 depicts configurations in which single product 462 stages receive input from raw material 460 and electricity 472, with recycling 468 returning recovered material to product 462. Second example solution 454 depicts configurations in which two product 462 stages operate within value-chains, representing more complex routing of material flows between raw material 460, electricity 472, customer 464, segregation 466, recycling 468, and down-cycling 470.

Selection between first example solution 452, second example solution 454, and other available configurations within Pareto-optimal solutions 408 is governed by decision variables of multiperiod planning function 300. Consumer demand may be distributed between multiple selected configurations simultaneously, with fractions of demand satisfied by each configuration represented by continuous variable xₖ∈[0,1] as described with respect to FIG. 4A. Net-zero framework 170 selects combinations of configurations that minimize total cost, including value-chain operating cost 340, research and development cost 342, and cumulative emissions cost 344 (see FIG. 3), while satisfying constraints defined in constraints 315.

### NOMENCLATURE

Nomenclature utilized herein includes the following indices, parameters, sets, and variables. The subscript represents indices, and the superscript indicates associations of defined variables and parameters.

### Indices:

i∈ [symbol] : Innovation item.

k∈ [symbol] : Pareto-optimal value-chain solution (each satisfying consumer demand).

τ∈ [symbol] : Time period.

### Parameters:

$${v}_{a}^{i} :$$

1/Mean of the sojourn time distribution in the TRL state a for the ith innovation.

θₖ: Circularity of the kth compromise solution, measured in terms of monetary regeneration factor.

Circₖ: Monetary circularity of the kth compromise solution.

$${Em}_{k}^{elec} :$$

GHG emissions from electricity generation within the k^{th} compromise solution at τ=0.

Emₖ: GHG emissions from the k^{th} compromise solution at τ=0.

MCRLᵢ: Marginal cost to increase the readiness level (RL) of the ith innovation by 1 unit through organizational investments.

N: Number of time periods.

$${P}_{ab}^{i} :$$

Transition probability from an RL state Sₐ to S_{b} for the ith innovation, element in the transition matrix of an embedded discrete-time Markov chain DTMC, Pⁱ∈ [symbol] .

Q: Rate matrix of the continuous-time Markov chain (CTMC).

RCP_{rf}: Scenario corresponding to the representative concentration pathway, which ensures radiative forcing of rfW/m², rf ∈, where rf=2.6, 3.4, 4.5, 6.0, or baseline.

Sₐ: Discrete state of the continuous-time Markov chain (CTMC), indicating the readiness level of an innovation, a∈{1, 10}.

TH: Time horizon length.

τ̅: Year number corresponding to each period,

$$\{ 2020 … ( 2020 + \frac{τ N}{T} TH ) … 2055 \} .$$

### Sets:

[symbol] : List of innovations, f1:: i:: 10 g.

[symbol] ∈ [symbol] : List of Pareto-optimal (or compromise) solutions for each innovation in [symbol] , {1 . . . k . . . 240}.

[symbol] : List of time periods, {1 . . . τ . . . N}.

### Variables

GHG_{τ}: Greenhouse gas emissions in kgCO₂ equivalents at the beginning of the time period τ.

GHG_{cum}: Cumulative greenhouse gas emissions in kgCO₂ equivalents accrued throughout the time horizon.

IAM_{τ}: Ratio of emission intensity (kgCO₂/MW, where MW denotes megawatt) from electricity generation at time period r to emission intensity at τ=0, that is, 2020.

RLᵢ: Readiness level of innovation i at time of investment, t_{iτ}, when y_{iτ}≥0.

t_{iτ}: Time of investment in the ith innovation during time period τ, is 0 if the investment is made in previous time periods, at the beginning of τ, or not made at all, continuous ∈[0, TH/N].

t_{kτ}: Time of adopting the kth compromise solution during time period τ, continuous ∈[0, TH/N].

x_{kτ}: Fraction of consumer demand satisfied by Pareto-optimal solution k at the end of the time period τ, continuous ∈[0, 1].

y_{iτ}: If innovation i is invested in during time period τ, binary.

y_{kτ}: If Pareto-optimal solution k is selected to meet consumer demand during time period τ, binary.

Equation 1 utilizes multiperiod planning constraints, Evolution of innovation TRLs, IAMs, Climate change target, US Plastics Pact Target, and a Cumulative CO₂ emissions cap. Equation 1 is set forth below, as follows:

$${{min}_{{y}_{i τ} , {t}_{i τ}}}_{{x}_{k τ} , {y}_{k τ} , {t}_{k τ}} z := {\sum }_{τ ∈ 𝕋} [ {\sum }_{k ∈ {𝕂}_{i}} {OPEX}_{k} + {\sum }_{i ∈ 𝕀} R \& D {Cost}_{i} \{ {RL}_{max} - 𝔼 [ {RL}_{i} ] \} ] + Carbon tax$$

$$s . t . {f}_{1} ( x , y , t ) \geq 0 ,$$

$${RL}_{i} = {f}_{2}^{i} ( {t}_{i} ; ) \geq 0$$

$$A ( {t}_{k} ) = {f}_{3}^{k} ( {A}_{0} , {RCP}_{rf} , {t}_{k} )$$

$$GHG ( x , y , {t}^{GHG = 0} ) \leq 0$$

$$Circularity ( x , y , {t}^{θ \geq θ *} ) \geq 1.0$$

$${\sum }_{k , τ} {f}_{4} ( {x}_{k} , {t}_{k} , A ( {t}_{k} ) ) \leq B$$

$${y}_{i τ} , {y}_{k τ} ∈ ℤ ∈ \{ 0 , 1 \}$$

$${x}_{k τ} = ℝ ∈ [ 0 , 1 ]$$

$${t}_{i τ} , {t}_{k τ} ∈ ℝ , τ ∈ ℤ = \{ 1 ¨ 7 \} .$$

General multiperiod planning constraints, denoted as ƒ₁ in Equation 1, are described. These constraints form the basis for making planning decisions depicted in FIG. 4.

Which innovations should be chosen for investment, and when? If an innovation is invested in, which compromise solution on the Pareto-front corresponding to the chosen innovation should be selected for adoption, and when?

If multiple compromise solutions are favorable, how should consumer demand be distributed amongfavorable compromise solutions? The decision variables of the planning problem that capture the above choices are as follows: Whether an investment is made in innovation i within time period τ, denoted as y_{iτ}∈ [symbol] .

Whether a compromise value-chain solution k∈ [symbol] on the innovative Pareto-front corresponding to innovation i is chosen to satisfy consumer demand in time period τ, denoted as y_{kτ}∈ [symbol] . The greenhouse gas (GHG) emissions from each value-chain solution are recorded in the parameter Emₖ, and circularity is measured in terms of the monetary regeneration factor, denoted as θₖ.

The fraction of consumer demand satisfied by a compromise value-chain solution (k) in time period τ, denoted as x_{kτ}∈ [symbol] .

The overall optimization formulation for net-zero framework 170, depicted in FIG. 3, consists of objective functions 310 computed from decision variables and corresponding constraints 315 on these variables to capture technology readiness evolution, changing upstream emissions, and targets.

To ensure proper allocation of resources and define time periods of availability of innovations, the following structural constraints are added upon the decision variables: Once an innovation is invested in during a time period, it is activated and made available for all time periods following this time period, set forth according to Equation 2, as follows:

y_{i(τ+1)}≥y_{iτ}∀V∈ [symbol] ,τ∈{1 . . . N~1}.

After investment in an innovation (i), all value-chain solutions on the corresponding Pareto-front (k∈ [symbol] ) become available for adoption. A single such Pareto-optimal (or compromise) solution is chosen in a particular time period for adoption, set forth according to Equation 3, as follows:

$${\sum }_{k ∈ {𝕂}_{i}} {y}_{k τ} \leq {y}_{i τ} ∀ i ∈ 𝕀 , τ ∈ \{ 1 . . N \} .$$

If a Pareto-optimal solution (k) is chosen for adoption, the multiperiod planning function provided by net-zero framework 170 can distribute the consumer demand (or functional unit) between all chosen options. This is denoted using a continuous variable bound between [0,1], which is nonzero for k only if it is chosen for adoption, set forth according to Equation 4, as follows:

y_{kτ}≥x_{kτ}∀_{kτ}∈ [symbol] ,τ∈{1 . . . N}

0≤x_{kτ}≤1, [symbol] .

Selection of a Pareto-optimal solution (k) on a Pareto-front corresponding to innovation i occurs after investment is made in i, set forth according to Equation 5, as follows:

$${\sum }_{k ∈ {𝕂}_{i}} {t}_{k τ} \geq {t}_{i τ} ∀ i ∈ 𝕀 , τ ∈ \{ 1 . . N \} .$$

If an investment is made in innovation i during a time period τ, the value of the continuous variable t_{iτ}, indicating the time of investment, is allowed to be between 0 and (TH/N). Here, TH denotes the entire time horizon duration, and N denotes the number of time periods considered. This is ensured by imposing the following constraint, set forth according to Equation 6, as follows:

(TH/N)y_{iτ}≥t_{iτ}∀i∈ [symbol] ,τ∈{1}

(TH/N)[y_{iτ}−y_{i(τ-1)}]≥t_{iτ}∀i∈ [symbol] ,τ∈{2 . . . N}.

The above three constraints simultaneously ensure that adoption of a value-chain solution from innovation i, that is, k∈ [symbol] , is possible anytime after investment is made in innovation i, that is, after tᵢ.

It is also possible to further restrict the generation of optimal roadmaps by introducing constraints to have a prescribed rate (i) of adopting value-chains through the constraint set forth as follows:

x_{k,τ+1}−z_{k,τ}≤η×(TH/N+t_{k,τ+1}−t_{k,τ).}

Such a constraint may be added when the length of each time period is very small compared to the total length of the time horizon, that is, TH/N<<TH, and the rate parameters can be estimated with certainty.

Notably, the above constraints are valid across multiple time periods in the time horizon, with few continuity and inventory-type constraints to ensure all investments in innovations result in the future availability of value-chain solutions corresponding to the invested innovations. This choice can be understood as traversal from one innovative Pareto-front to another in the objective domain across different time periods, as shown in FIG. 4A.

Evolution of Eco-Innovations: One shortcoming of recent research on planning for climate action is its failure to account for the dynamic nature of each innovation's readiness for adoption. This omission affects the estimation of when an innovation will become available for adoption in the network. Conversely, net-zero framework 170 captures this attribute within the planning optimization methodology. The investment required for an innovation at any time is assumed to be directly proportional to how far the readiness level (RL) of the innovation at that time is from the RL corresponding to the diffusion stage (RLₘₐₓ). The RL of an innovation is modeled either deterministically or stochastically as a function of time. Therefore, as the RL evolves over time, the cost needed to bring the innovation closer to adoption also changes. Additionally, an investment is required to make all the Pareto-optimal solutions on the innovative Pareto-front available for adoption in order to meet the climate change and circularity targets set by the user. Thus, the evolution of the RL of innovations is important for multiple reasons within the multiperiod planning function provided by net-zero framework 170. Regardless of how this evolution is modeled, to solve the optimization problem, net-zero framework 170 applies surrogates for these typically nonlinear evolution profiles using piecewise linear functions for easier integration with the multiperiod planning constraints.

S-curves (Deterministic): Conventionally, consulting firms and venture capitalists use learning curves, experience curves, and S-curves to estimate the cost and maturity of new ventures, technologies, and programs. These are deterministic curves that depend on a few parameters defined by experts and stakeholders. For instance, one report alludes to using S-curve methodology to estimate market penetration of Circular Economy-related innovations. The report quantifies market penetration according to Equation 7, set forth below, as follows:

$$y = {y}_{0} + \frac{1}{1 + {e}^{- c ( t - {t}_{0} )}} .$$

Here, t₀, y₀ denote the initial values of time and market share, and the coefficient c is determined using a scoring method provided to experts. The score is calculated based on the number of competing technologies, the stakeholder groups involved, and the disruption of current technologies. These curves can be considered heuristics to model the evolution of the Technology Readiness Levels (TRLs) of all innovations, which will be surrogates for piecewise linear functions and added to the multiperiod planning function provided by net-zero framework 170. While this is a simpler approach with a lower need for user parameters (three scores), it is limited in terms of the behavior it can model, as it only represents sigmoidal curves.

Options Theory and Portfolio Management Approaches: Prior approaches rely on heuristics and market surveys, while others employ more quantitative and mathematically rigorous methods. A trade-off between the level of rigor and the number of parameters required for estimation is evident, as discussed above. For example, one prior technique creates a roadmap for drug development within a pharmaceutical company, navigating various Technology Readiness Level (TRL) stages, while allowing for decision continuation or abandonment and accounting for market risk. Although this approach proves highly useful and robust, it necessitates manual user intervention in the form of stakeholder input, such as estimates of market volatility and risk-neutral probabilities, and also involves complex decomposition techniques to ensure computational feasibility. In contrast, a simpler and less data-intensive approach is described using net-zero framework 170, which models the evolution of readiness levels using Continuous-time Markov Chains (CTMC). This technique is especially suitable for modeling diverse innovations that span across the value chain, as opposed to drug development, which typically involves a single stakeholder.

Markov Chains (Stochastic Technology Forecasting): Continuous-time Markov Chains (CTMCs) are stochastic processes that can be employed to model the probabilistic evolution of Technology Readiness Levels (TRLs), which are represented within a discrete- [symbol] state space (e.g., TRL= [symbol] ∈[1,10]). CTMCs satisfy the Markovian property, meaning the transition probability from state A to state B at a particular time is independent of how the process reached state A, and the time spent in a state, known as sojourn time, follows an exponential distribution. Several methods exist for modeling technology forecasting, and the use of CTMCs to model TRLs over time is justified for the following reasons:

First, TRLs can be treated as discrete states, and the evolution between these TRL states may be assumed to follow a Markov process. For instance, the probability of an innovation transitioning from the pilot plant state (TRL=4) to the commercialization state (TRL=6) does not depend on the manner or timing in which the innovation reached the pilot plant state from the research and development (R&D) phase.

Second, sojourn times indicate the duration an innovation spends in each state, which can be assumed to follow an exponential distribution. For technology and innovation readiness, these parameters represent tangible and measurable characteristics. For example, the likelihood of transitioning from pilot plant stages to commercialization is often probabilistic due to the large number of innovations involved. Additionally, the time required at each stage of technology development frequently follows an exponential distribution, supported by historical evidence. The stochastic property of CTMCs, therefore, enables the use of these probabilities and distributions to simulate the dynamics of real-time technology evolution scenarios.

Since CTMCs can be viewed as a collection of independent, competing exponential random variables, the next state, S_{c}, from an initial state, Sₐ, may be determined according to Equation 8, set forth below, as follows:

S_{c}∈argmin{T_{ab},b≠a}, where T_{ab}~exp(vₐP_{ab})

Here, vₐ represents the reciprocal of the expected sojourn time at state Sₐ, and P_{ab} denotes the probability of transition from state Sₐ to S_{b} in an embedded Discrete-time Markov Chain (DTMC). The instantaneous transition rates between any two states (q_{ab}) in a CTMC—and subsequently the rate matrix Q=[q_{ab}]—can be found according to Equation 9, set forth below, as follows:

$${q}_{ab} = \{ \begin{matrix}{v}_{a} {P}_{ab} , & if a \neq b \\ - {v}_{a} , & if a = b\end{matrix} .$$

The dependence of q_{ab}, and correspondingly the instantaneous state S(t), on sojourn time suggests that the expected duration in a particular TRL state may impact the transient behavior and evolution profiles, alongside the actual transition probabilities between TRL states. Although the rate matrix (Q) fully characterizes the CTMC, the most important parameters that can be estimated or provided are: a) the mean of sojourn times, and b) the transition probabilities for the embedded DTMCs. The Chapman-Kolmogorov forward equation may be employed to derive the transient probabilities of the stochastic process being in a particular state at time t, given the initial state SO, as expressed according to Equation 10, set forth below, as follows:

P(t)=P(t=0)·e^{Qt}.

The exponential of the rate matrix is computationally difficult to calculate, and several methods, such as Euler expansion, exist to obtain approximate solutions. The Eigen-decomposition method is used when Q is diagonalizable, and can express Q=ADA⁻¹, where D=diag(λ₁,λ₂ . . . ), and λ's are the eigenvalues. This approach simplifies and enables the Euler expansion of each of the scalars e^{λ}^{ₐ}^{t} independently, according to Equation 11, set forth below, as follows:

e^{Qt}=Ae^{Dt}A⁻¹,e^{Dt}=diag(e^{λ}^{ₐ}^{t},e^{λ}^{_{b}}^{t}, . . . ).

The transient probabilities of the Markov process being in various states, S, given the initial state Sₐ, can be derived according to Equation 12, set forth below, as follows:

$$P ( t ) = ( \begin{matrix}{p}_{a} ( t ) \\ {p}_{b} ( t ) \\ ¨ \\ ¨\end{matrix} ) = ( \begin{matrix}1 \\ 0 \\ 0 \\ ¨\end{matrix} ) \cdot {e}^{Qt} .$$

This probability distribution, P(t), may be used to identify the expected value of the CTMC state, or TRL of innovation i, at any given time t. The expected behavior of the CTMC and the expected readiness level of innovation i at time t, according to Equation 13, set forth below, as follows:

$$𝔼 [ {RL}_{i} ] ( t ) = 𝔼 [ S ] ( t ) = {\sum }_{s ∈ states} {S}_{s} {p}_{s} ( t ) .$$

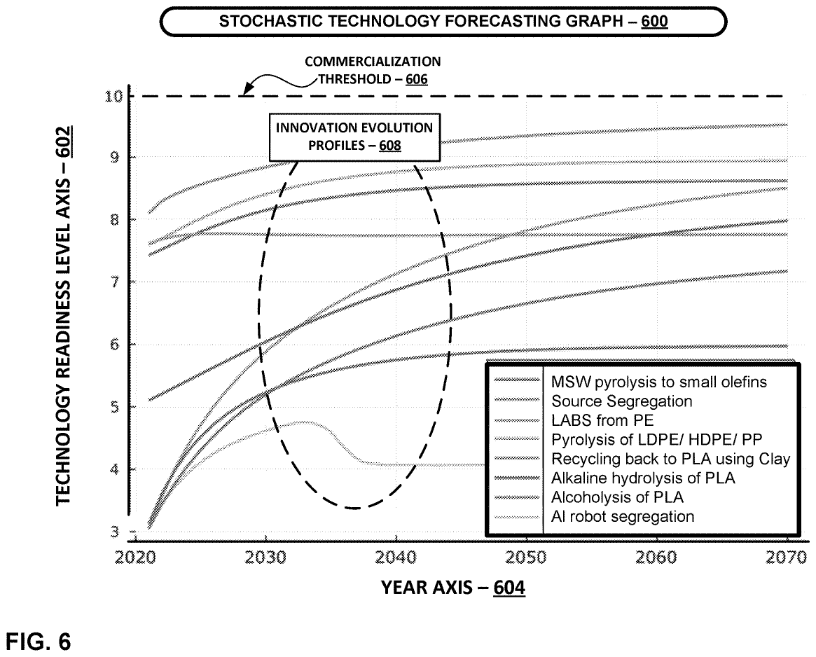

While these decomposition and Euler-expansion techniques simplify the computation and simulation of CTMCs, they still involve non-linearities that should ideally be avoided in a multiperiod planning optimization model, as described above. Additionally, since the CTMC attributes such as P_{ab}, vₐ, Q can be estimated beforehand, they would function merely as parameters within the optimization model, with the states indicating the TRL of a specific innovation. Therefore, the evolution profiles of each innovation may be simulated prior to the optimization. Refer to the description of FIG. 6 below for a case study. Ultimately, these temporal profiles are approximated using piecewise linear functions with optimized breakpoints, which are incorporated into the multiperiod planning problem, denoted as ƒ₂(⋅) in Equation 1 provided above.

Practical Data Acquisition Limitations: Data collection for certain deterministic models is generally easier than for their stochastic counterparts. However, deterministic models often serve only as heuristics for specific innovations and are highly sensitive to inputs from industry experts, the sector of innovation, and other factors. Rigorous models, such as real-options theory, are well-suited for industry-specific problems with clearly defined parameters and uncertainties. Nevertheless, such models tend to be complex, making their inclusion into road-mapping efforts challenging. While the Continuous-time Markov Chain (CTMC) approach addresses these shortcomings and shows promise for modeling technology evolution, CTMC still requires numerous parameter inputs, such as mean sojourn times and transition probabilities. The estimation of these parameters from historical bibliometric data for various novel technologies is an ongoing effort.

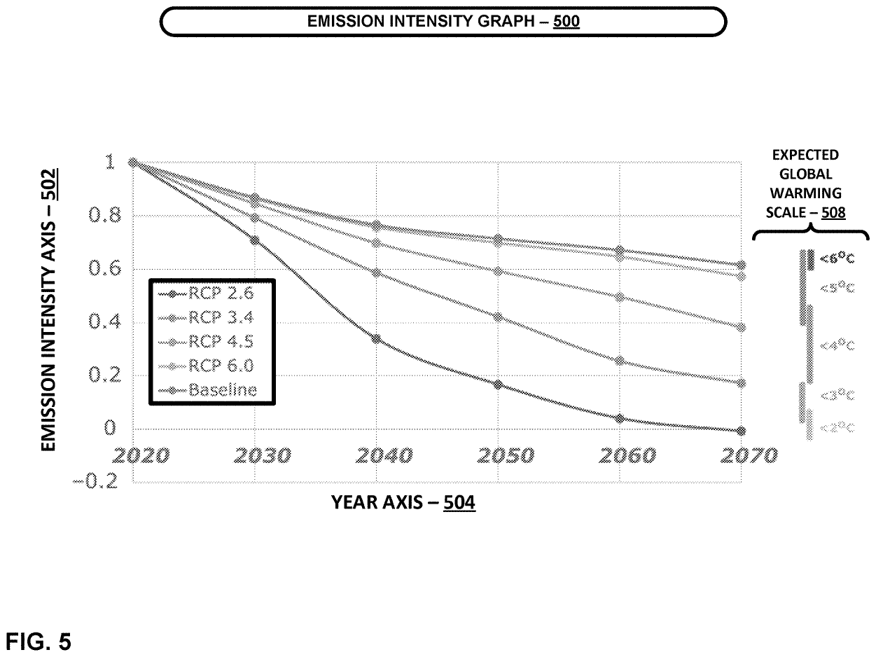

FIG. 5 depicts emission intensity graph 500, illustrating emission intensity from electricity generation projected for the United States in the future considering a middle-of-the-road shared socioeconomic pathway (SSP2) scenario, in accordance with aspects of this disclosure.

Emission intensity graph 500 presents emission intensity axis 502 on the vertical axis, representing emission intensity with respect to 2020 baselines, and year axis 504 on the horizontal axis, spanning from 2020 through 2070. Expected global warming scale 508 is presented on the right side of emission intensity graph 500 and associates each representative concentration pathway (RCP) scenario curve with corresponding projected ranges of expected global warming in degrees Celsius.

Emission intensity graph 500 depicts five projected emission intensity profiles corresponding to RCP 2.6, RCP 3.4, RCP 4.5, RCP 6.0, and baseline scenarios. Each profile represents how emission intensity of electricity generation sectors changes over time under different combinations of shared socioeconomic pathway and RCP scenario assumptions. Scenarios depicted in emission intensity graph 500 were constructed using integrated model to assess the global environment (IMAGE) type of integrated assessment model (IAM).

IAM is a complex field within ecological economics that integrates aspects from various scientific disciplines to model Earth systems, human interactions, and policy. IAM has been successfully applied to support numerous climate change decisions and policies, such as the Millennium Ecosystem Assessment. IMAGE type IAM models have been employed to understand long-term impacts of global changes resulting from interactions of socioeconomic and environmental factors. IMAGE has been used to simulate future emissions from electricity generation sectors, considering growth in electricity demand across various shared socioeconomic pathways (SSP 1 through 5), and policy actions aimed at meeting greenhouse gas (GHG) concentration targets set according to representative concentration pathways for following radiative forcing values in 2050: RCP 2.6, 3.4, 4.5, and 6.0 watts per square meter (W/m²). These two parameters are used to estimate emission intensity of electricity generation sectors in the future for each combination of SSP and RCP scenarios.

Profiles shown in emission intensity graph 500 represent how decarbonization of energy systems affects upstream life cycles of various value-chain alternatives, thus influencing future decisions made by net-zero framework 170 (see FIG. 1). More stringent climate action policies, corresponding to lower RCP values such as RCP 2.6, yield steeper reductions in emission intensity over year axis 504, with RCP 2.6 curves approaching and crossing zero on emission intensity axis 502 by approximately 2070. Less stringent scenarios, such as RCP 6.0 and baselines, result in more gradual reductions, with emission intensity remaining substantially above zero throughout projection periods.

Mathematically, these emission intensity profiles are represented within multiperiod planning function 300 (see FIG. 3) as piecewise linear functions of time, expressed as IAM_{τ}=f₃(RCP_{3.4}, τ), as shown in optimization formulations described herein. This correction factor IAM_τ serves as a time-dependent multiplier applied to emissions generated from electricity in selected value-chain solutions, denoted

$$( {Em}_{k}^{elec} ) ,$$

and is incorporated into changing background emissions 354 within constraints 315. By applying (IAMτ), net-zero framework 170 accounts for upstream decarbonization effects on life-cycle GHG emissions of value-chain solutions across time horizons, ensuring that transition roadmap output 176 (see FIG. 1) reflects realistic projections of how grid decarbonization will reduce scope 2 and scope 3 emissions attributable to electricity consumption within each value-chain configuration.

Expected global warming scale 508 provides contextual correspondence between each RCP scenario curve and projected global warming outcomes, ranging from less than 2 °C for most stringent scenarios to less than 6 °C for baseline scenarios. This correspondence illustrates relationships between climate action policy stringency, electricity grid decarbonization trajectories as depicted in emission intensity graph 500, and resulting feasibility of achieving net-zero emissions targets within value-chain networks evaluated by net-zero framework 170.

Carbon Neutrality and Circularity Targets as Constraints: Net-zero framework 170 may generate and output roadmaps for meeting future environmental targets based on constraints defined by the stakeholders. In certain cases, when targets are set for the end of the time horizon, these targets may represent terminal constraints. However, it is recommended to extend the time horizon by adding an additional time period to yield meaningful results for the final time period. The carbon neutrality target can be ensured by introducing a constraint according to Equation 14, set forth below, as follows:

$${GHG}_{τ} = {\sum }_{k} {x}_{k , τ} ( {Em}_{k} - {Em}_{k}^{elec} [ 1 - {IAM}_{τ} ] ) ∀ τ ∈ 𝕋 {GHG}_{{τ}^{*}} \leq 0 ∀ τ * ∈ 𝕋 s . t . \overline{τ} ( τ \text{*)} \geq {t}^{GHG = 0} .$$

The emissions at timestep r are calculated by multiplying the emissions from a compromise solution k (Emₖ) by a factor estimated from the IAM(IAM_{τ}), which indicates the expected change in emissions intensity due to climate change policy and mitigation measures, based on predicted shared socioeconomic conditions and CO2 concentration pathways. Similar to Equation 14, where constraints are set to achieve greenhouse gas (GHG) emission targets, recycling and upcycling constraints can also be imposed on circularity (θ), ensuring compliance with the Plastics Pact or other organizational constraints. This ensures that the circularity target exceeds a defined threshold (θ*) for τ̅(C*)≥t^{θ≥θ}*. These terminal constraints guarantee that the optimal roadmap satisfies constraints concerning net-zero emissions, carbon neutrality, or upcycling after a user-defined point in the time horizon.

Carbon Budget Utilization: When determining a potential roadmap to optimally meet emissions targets by the end of a specified time horizon, net-zero framework 170 may be configured to ensure that transition roadmap output 176 does not result in excessive greenhouse gas emissions during an entirety of the given time horizon. For this reason, a variable is formulated to track the cumulative (or accrued) greenhouse gas emissions throughout the time horizon. As mentioned above, the multiperiod planning function provided by net-zero framework 170 enables the selection of Pareto-optimal solutions to distribute consumer demand. At each time period, a particular solution can be selected, deselected, or retained. This decision is recorded in the y_{k,tt} binary variable.

The importance of carbon budgets during the time horizon influences how the cumulative greenhouse gas emissions objective is formulated. This objective may be represented either as a linear approximation or as a more complex nonlinear objective that records the exact timing of when a solution is selected within a time period. In the linear formulation of cumulative greenhouse gas emissions (denoted (GHG_{cum.}), the average emissions from two selected solutions at the beginning and end of any given time period (t=τ̅_{τ-1} and t=τ̅_{τ}) are multiplied by the duration of the time period, which is represented as (TH)/N, set forth below according to Equation 15, as follows:

$${GHG}_{cum .} = \frac{T H}{2 N} {\sum }_{τ} ( {\sum }_{k} {x}_{k τ - 1} \{ {Em}_{k} - {Em}_{k}^{elec} [ 1 - {IAM}_{τ - 1} ] \} ) + ( {\sum }_{k} {x}_{k τ} \{ {Em}_{k} - {Em}_{k}^{elec} [ 1 - \vert {AM}_{τ} ] \} ) .$$

Nonlinear Formulation of Carbon Budget Utilization: The nonlinear formulation, in contrast, tracks each transition point over every time period and calculates the net emissions resulting from the various value-chain solutions implemented over a nonzero time span. However, incorporating this approach into the optimization model requires additional constraints within the multiperiod planning formulation to ensure that the functional unit, or consumer demand, is met between two separate transitions. This added complexity can be mitigated by reducing the duration of the time periods, which would not introduce significant computational load, as the problem scales linearly with the increase in the number of time periods (N). Another alternative is to use a slightly more complex time-based weighted average of the two emission snapshots. The weights can be estimated as an effective transition point, tt_{τ}. This transition point can be calculated using Equation 16 below, which normalizes the fraction of adopted Pareto-optimal solutions (k) against the total number of available solutions, denoted by Σₖ 1, according to Equation 16, as follows:

$$2 ( {\sum }_{k} 1 ) {tt}_{τ} = {\sum }_{k} [ ( {\sum }_{k} {x}_{k , τ - 1} ) {t}_{k τ} + ( {\sum }_{k} {x}_{k , τ} ) {t}_{k τ} ] where ,$$

$${IAMI}_{τ} = {f}_{3} ( {RCP}_{rf} , {tt}_{τ} ) .$$

Nonlinear Formulation of Cumulative GHG Emissions: Correspondingly, the nonlinear formulation of cumulative greenhouse gas (GHG) emissions can be expressed as shown in Equation 17, set forth below, as follows:

$${GHG}_{cum .} = {\sum }_{τ} {t}_{τ} ( {\sum }_{k} {x}_{k τ - 1} \{ {Em}_{k} - {Em}_{k}^{elec} [ 1 - {IAM}_{τ - 1} ] \} ) + ( TH / N - {tt}_{τ} ) ( {\sum }_{k} {x}_{k τ} \{ {Em}_{k} - {Em}_{k}^{elec} [ 1 - {IAMM}_{τ} ] \} ) .$$

In this formulation, the weight (ttₖ) is a bilinear function of xₖₜ and tₖₜ, causing the cumulative GHG emissions to become a cubic function of the decision variables. Many commercial solvers, such as Gurobi, can now handle quadratic constraints. Therefore, the nonlinearities in the approximated time point of the shift, tt_{τ}, arising from t_{kτ}x_{kτ} in the above equation, have been converted into quadratic constraints using McCormick Relaxations. Given that the variables have comparable lower and upper bounds, these affine relaxations are expected to exhibit high convergence rates and satisfactory tightness. The modified equation for tt_{τ}, which transforms the previous equation into a quadratic form, as shown in Equation 18, set forth below, as follows:

$$( {\sum }_{k} 1 ) {tt}_{τ} = {\sum }_{{k}_{1}} ( {\sum }_{{k}_{2}} {w}_{{k}_{1} , {k}_{2} , τ}^{1} ) + ( {\sum }_{k 2} {w}_{{k}_{1} , {k}_{2} , τ}^{2} ) , where ,$$

$${w}_{{k}_{1} , {k}_{2} , τ}^{1} = McCormick Relaxations ( {x}_{{k}_{1} τ} , {x}_{{k}_{2} , τ} , {t}_{k , τ} )$$

$${w}_{{k}_{1} , {k}_{2} , τ}^{2} = McCormick Relaxations ( {x}_{{k}_{1} , τ - 1} , {x}_{{k}_{2} , τ - 1} , {t}_{k , τ} ) and ,$$

$${k}_{1} , {k}_{2} ∈ 𝕂 .$$

There are several ways to penalize large cumulative greenhouse gas (GHG) emissions, including introducing caps (or budgets), taxation, and ecosystem capacity limits. In one case study described below, taxation is utilized since it requires a single parameter input, specifically the carbon tax per kilogram of CO2 equivalent emissions. On the other hand, estimating carbon budgets and understanding true carrying capacity remain active research questions and involve a considerable degree of subjectivity. In this analysis, a fixed carbon tax of $120 per ton of CO2 equivalent emissions is imposed during the time horizon and is incorporated into the cost minimization objective.

Annualized investment cost for eco-innovation adoption: The cost of adopting eco-innovation at a particular time during the time horizon is assumed to be directly proportional to the marginal difference between the expected readiness level ( [symbol] [RLᵢ](t)) of innovation i at time t and the maximum possible value of the readiness level (RLₘₐₓ). The term RLₘₐₓ typically corresponds to the diffusion or adoption stage. The multiplying factor is a parameter referred to as the marginal cost to increase the readiness level by one unit (MCRL). Since the investment to advance a particular innovation to the diffusion stage occurs at a future point in the time horizon, the cost is discounted to account for the time value of money using a discount rate of r. Ultimately, the cost is incurred only if the innovation is selected for investment during the time period τ, as represented by the expression (y_{i,τ+1}−y_{i,τ}). The resulting expression for the total investment cost for all selected innovations is provided by Equation 19 below, set forth as follows:

$$Investment cost = {\sum }_{τ ∈ 𝕋} {\sum }_{i ∈ I} ( {y}_{i , ( τ + 1 )} - {y}_{i , τ} ) \frac{{MCRL}_{i} [ {RL}_{max} - 𝔼 [ {RL}_{i} ] ( {t}_{i} ) ]}{{( 1 + r )}^{{t}_{i}}} .$$

As mentioned above, the inclusion of detailed stochastic models for the evolution of readiness levels (RL) within optimization is unnecessary if the decision variables do not influence the transition probabilities or sojourn times of the continuous-time Markov chain (CTMC). This assumption holds if climate change models or external investments do not alter the natural evolution profile, which can be obtained from historical data. Under this assumption, the nonlinearity of the expression is eliminated by simulating CTMCs and creating a piecewise linear surrogate model for each innovation, which describes the investment cost as a function of time (ƒ₂(t)). The choice of the continuous decision variable ti for the time of adoption, therefore, depends on the developed surrogate model. In addition to the investment cost, the cost objective also includes the “present” value of the operating cost (OPEX) of the selected compromise solutions on the Pareto front within the time horizon. This is estimated using the life-cycle cost of natural resources (LCC) recorded in the input dataset. It is also possible to include the cost of shifting away from a selected solution by introducing a new binary variable,

$${y}_{k , τ}^{Close} \geq {x}_{k , τ} - {x}_{k , τ + 1} ,$$

to the objective function with a cost coefficient. In long-term road-mapping problems, where adequate measures can be implemented to shift from one value chain to another far in the future, such penalizations may not be necessary and could lead to sub-optimal solutions. Notably, retrofitting technologies can also be included as an alternative in the road-mapping framework by incorporating the improved values of global warming potential (GWP) and/or circularity. The RL profile for retrofitting solutions will be a step function from 0 to RLₘₐₓ at the specified time of maintenance or plant turnarounds. Once this alternative is included, the multiperiod planning function provided by net-zero framework 170 will automatically choose between innovations that can radically change the value chain and retrofitting options, if available.

### Case Study:

The multiperiod planning function provided by net-zero framework 170 is demonstrated via a case study for packaging eco-innovations within the grocery bags value chain in the United States, aimed at achieving net-zero emissions and circularity. These innovations have the potential to disrupt any part of the value chain, which includes the cradle-to-cradle network involved in the production, use, reuse, recycling, and end-of-life management of five types of grocery bags: polyethylene (both high and low density), polypropylene, poly-lactic acid (PLA), and paper. Each type of bag possesses a unique volume carrying capacity, weight, and reusability. Innovations may originate from any domain, including technologies for mechanical or chemical recycling, increasing reuse, and segregation programs. A previously developed methodology for screening and ranking eco-innovations identifies the ten most promising alternatives based on a utopia point shift criterion, evaluated using a multi-objective optimization routine on cradle-to-cradle life-cycle networks. The screened innovations are: (i) Municipal solid waste (MSW) pyrolysis to olefins, (ii) Source segregation programs, (iii) AI-assisted image classification for MSW sorting, (iv) Linear alkyl benzenes from waste polyethylene, (v-vii) Pyrolysis of segregated plastics, (viii) Recycling of PLA to polymer resin through mononitrile clay catalyst, (ix) Alkaline hydrolysis of PLA to lactic acid monomer, and (x) Alcoholysis of PLA to methyl lactate. The outcome of this methodology is a range of innovative Pareto fronts, with numerous compromise solutions. The choice among these solutions determines the distribution of consumer demand, specifically the annual volume carrying capacity of 100 million households in the United States for grocery shopping. The Pareto fronts for the ten selected innovations in this case study are presented in FIGS. 4A and 4B above. The optimal roadmap essentially traverses through several Pareto-optimal (or compromise) points in the time dimension, with a Pareto front becoming available only after a one-time investment. This is achieved using the multiperiod formulation described in Equation 1, provided above.

FIG. 6 depicts stochastic technology forecasting graph 600, illustrating simulated continuous-time Markov chains for innovations available in case studies, based on each corresponding sector, in accordance with aspects of this disclosure.

Stochastic technology forecasting graph 600 presents technology readiness level axis 602 on vertical axes, representing technology readiness level (TRL) values ranging from 3 to 10, and year axis 604 on horizontal axes, spanning from 2020 through 2070.

Commercialization threshold 606 is depicted as dashed horizontal lines at TRL 10, representing threshold TRLs for commercialization and adoption in markets. Innovation evolution profiles 608 identifies regions of particular interest in stochastic technology forecasting graph 600, corresponding to clusters of curves exhibiting crossing and diverging behavior approximately between 2025 and 2045, where stochastic evolution dynamics are most pronounced.

Legends within stochastic technology forecasting graph 600 identify simulated innovations: municipal solid waste (MSW) pyrolysis to small olefins, source segregation, linear alkyl benzenes (LABS) from polyethylene (PE), pyrolysis of low-density polyethylene (LDPE)/high-density polyethylene (HDPE)/polypropylene (PP), recycling back to polylactic acid (PLA) using clay, alkaline hydrolysis of PLA, alcoholysis of PLA, and artificial intelligence (AI) robot segregation. Each curve in stochastic technology forecasting graph 600 represents expected TRL evolution profiles of one of these innovations over time, simulated using continuous-time Markov chains (CTMCs) as described herein.

Technology forecasting for screened innovations is a useful aspect of road-mapping frameworks, as forecasting determines amounts of investment associated with making Pareto-optimal solutions adoptable at any given time using expected readiness level formulations described herein. Forecasting of technology is modeled using stochastic processes, specifically CTMCs. Due to computational complexity of analytical solutions for CTMCs, simulations are performed in advance for all innovations, and results are represented using piecewise linear functions incorporated into multiperiod planning function 300 (see FIG. 3).

Certain practical challenges exist in obtaining parameters needed to model CTMCs of simulated per-sector innovations. Therefore, insights and values from industrial stakeholders and collaborators may be integrated into analysis. Alternatively, limiting behavior may be utilized to fit CTMC parameters using, for example, academic and patent citation data about historical innovations.

As depicted in stochastic technology forecasting graph 600, innovations that begin at lower TRL values in 2020 exhibit steeper evolution trajectories, reflecting greater expected advancement over time horizons. Crossing behavior visible within innovation evolution profiles 608 illustrates stochastic nature of TRL progression, where innovations beginning at similar readiness levels may diverge significantly in adoption timing depending on transition probabilities and sojourn times assigned to each TRL state. Innovations that reach or approach commercialization threshold 606 earlier in time horizons become available for adoption sooner within optimal roadmaps generated by net-zero framework 170 (see FIG. 1), and correspondingly require lower investment costs due to reduced marginal gaps between expected readiness levels and maximum readiness levels at times of investment.

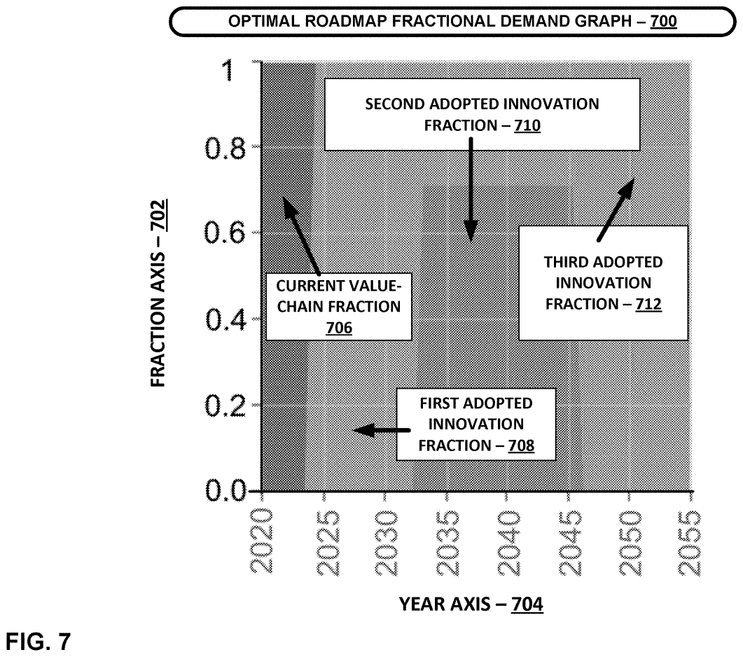

FIG. 7 depicts results for a shared socioeconomic pathway (SSP2) scenario, in accordance with aspects of the disclosure. For instance, FIG. 7 depicts optimal roadmap fractional demand graph 700, illustrating results for shared socioeconomic pathway (SSP2) scenarios showing proposed optimal combinations of innovations selected during time horizons to meet greenhouse gas (GHG) emissions and circularity targets while minimizing investment costs, value-chain operating costs.

Optimal roadmap fractional demand graph 700 presents fraction axis 702 on vertical axes, representing fractions of consumer demand satisfied by each selected value-chain configuration, ranging from 0.0 to 1.0, and year axis 704 on horizontal axes, spanning from 2020 through 2055.

Current value-chain fraction 706 represents portions of consumer demand satisfied by incumbent value-chain configurations prior to adoption of innovations. Current value-chain fraction 706 occupies substantial shares of fraction axis 702 from 2020 onward and decreases over time as adopted innovations progressively displace current value-chain fraction 706.

First adopted innovation fraction 708 represents portions of consumer demand assigned to first innovations selected for adoption by multiperiod planning function 300 (see FIG. 3). First adopted innovation fraction 708 corresponds to pyrolysis of LDPE and is selected for immediate investment in early periods of time horizons, as pyrolysis of LDPE reduces exploitation of carbon budgets at lower costs.

Second adopted innovation fraction 710 represents portions of consumer demand assigned to second innovations selected for adoption. Second adopted innovation fraction 710 corresponds to linear alkyl aromatics from PE and begins contributing to consumer demand satisfaction starting approximately in 2035, after reaching sufficient TRLs as modeled by CTMC simulations depicted in stochastic technology forecasting graph 600 (see FIG. 6). Second adopted innovation fraction 710 facilitates meeting upcycling requirements as circularity targets become binding.

Third adopted innovation fraction 712 represents portions of consumer demand assigned to third innovations selected for adoption. Third adopted innovation fraction 712 corresponds to PLA alkaline hydrolysis and begins contributing to consumer demand satisfaction starting approximately in 2050. Third adopted innovation fraction 712 contributes to emission reduction by displacing conventional lactic acid through alkaline hydrolysis and biogenic carbon sequestration. Despite initial low TRLs, this innovation is expected to evolve positively according to CTMC simulations, and lower time value of money in future periods encourages later investments and shifts toward this bio-based alternative.

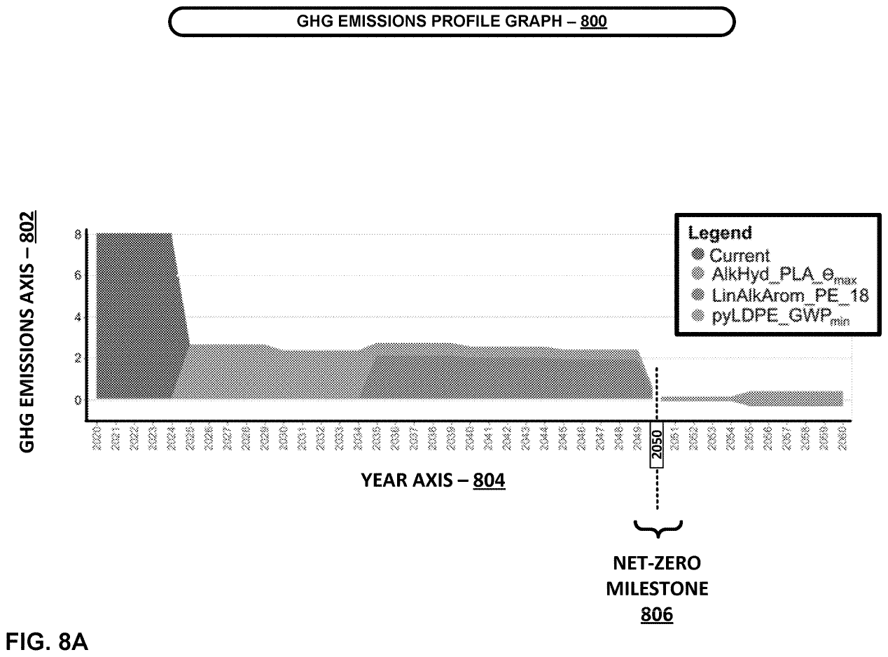

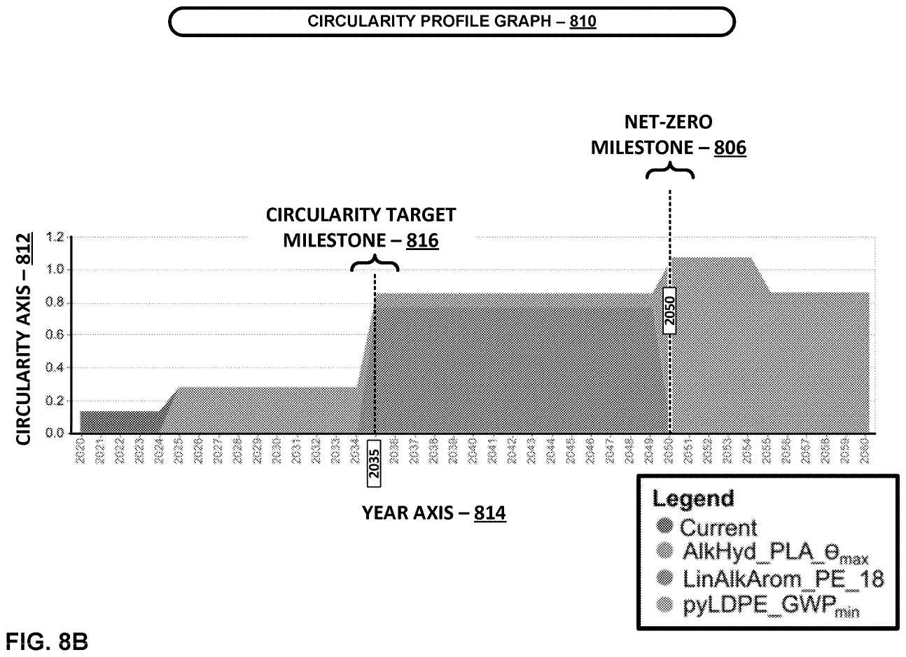

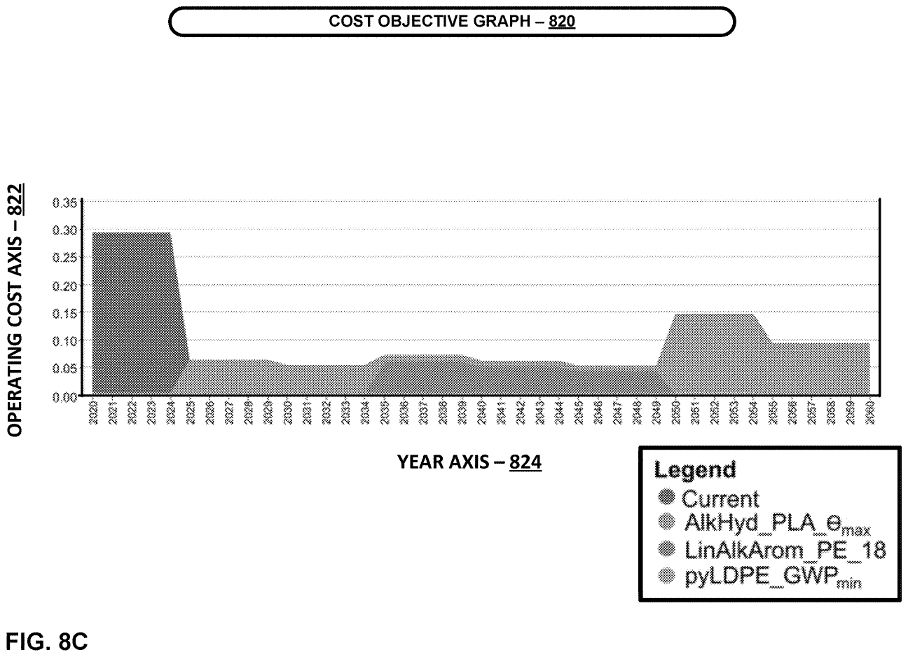

Outcomes depicted in optimal roadmap fractional demand graph 700 represent Gantt-chart-style roadmaps generated by net-zero framework 170 showing adoption of various innovative Pareto-optimal value-chain solutions at different points in time. Life-cycle GHG emissions reach net-zero starting in 2050, and circularity targets are met by 2035, as further illustrated in FIGS. 8A, 8B, and 8C. These roadmaps account for technology evolution, climate change policy, annualized operating and research and development costs, and provide comprehensive transition roadmap output 176 (see FIG. 1) for meeting environmental targets at lowest costs.

FIG. 8A depicts greenhouse gas (GHG) emissions profile graph 800, illustrating GHG emissions over time for the proposed optimal roadmap under the shared socioeconomic pathway SSP2 representative concentration pathway (RCP) 3.4 scenario, in accordance with aspects of this disclosure.

GHG emissions profile graph 800 presents GHG emissions axis 802 on the vertical axis, representing GHG emissions expressed in units of ×10³ million kgCO₂ equivalent per year, and year axis 804 on the horizontal axis, spanning from 2020 through 2060. Net-zero milestone 806 is indicated by a dashed vertical line at year 2050, marking the point at which life-cycle GHG emissions from the grocery bags value-chain reach net-zero under the optimal roadmap generated by net-zero framework 170 (see FIG. 1).

GHG emissions profile graph 800 depicts stacked area profiles corresponding to four value-chain configurations identified in the legend: the current configuration, AlkHyd_PLA_θ_max, LinAlkArom_PE_18, and pyLDPE_GWP_min. From 2020 through approximately 2024, the current configuration dominates GHG emissions axis 802, with total emissions near 8×10³ million kgCO₂ equivalent per year. Beginning in approximately 2025, adoption of pyLDPE_GWP_min, corresponding to pyrolysis of low-density polyethylene (LDPE) using a fluidized catalytic cracking (FCC) catalyst, reduces total emissions substantially. The stacked profile reflects sequential adoption of innovations corresponding to pyrolysis of LDPE, linear alkyl aromatics from polyethylene (PE), and poly-lactic acid (PLA) alkaline hydrolysis, with each transition producing a staggered reduction in emissions across year axis 804. The stacked profile remains relatively stable from approximately 2025 through 2049, reflecting continued operation of the selected value-chain configurations. At net-zero milestone 806, corresponding to year 2050, total life-cycle GHG emissions reach net-zero and remain at or near zero through 2060, confirming that net-zero emissions and circularity targets 356 (see FIG. 3) are satisfied within the time horizon. The cumulative effects of adopted innovations and changing background emissions 354 (see FIG. 3) contribute jointly to reaching net-zero milestone 806.

The multiperiod planning model depicted through GHG emissions profile graph 800 was implemented under configurable constraints and projections aimed at reaching the targets set for the grocery bags value-chain. The main target reflected in GHG emissions profile graph 800 is net-zero GHG emissions by 2050, calculated for a life-cycle system boundary. While most aspects of this case study are realistic and introduced with high confidence, certain elements are educated estimates for the prototype, including the research and development marginal cost per readiness level increase, continuous-time Markov chain (CTMC) parameters, carbon tax rate, and others. The results presented should therefore be viewed as an application of net-zero framework 170, with attention given to its ability to provide optimal roadmaps with numerous considerations, rather than as exact solutions for the grocery bags case study.

FIG. 8B depicts circularity profile graph 810, illustrating the evolution of value-chain circularity over time for the proposed optimal roadmap under the SSP2 RCP 3.4 scenario, in accordance with aspects of this disclosure.

Circularity profile graph 810 presents circularity axis 812 on the vertical axis, representing circularity expressed as monetary circularity θ ranging from 0.0 to 1.2, and year axis 814 on the horizontal axis, spanning from 2020 through 2060. Circularity target milestone 816 is indicated by a dashed vertical line at year 2035, marking the point at which the monetary circularity value exceeds 1.0, satisfying the upcycling requirement imposed by net-zero emissions and circularity targets 356 (see FIG. 3). Net-zero milestone 806 is indicated by a dashed vertical line at year 2050, consistent with the corresponding milestone depicted in GHG emissions profile graph 800 (see FIG. 8A), and is shown for temporal correlation.

Circularity profile graph 810 depicts stacked area profiles corresponding to the same four value-chain configurations identified in the legend: the current configuration, AlkHyd_PLA_θ_max, LinAlkArom_PE_18, and pyLDPE_GWP_min. From 2020 through approximately 2024, the current configuration contributes a low baseline circularity value near 0.1. Beginning in approximately 2025, adoption of pyLDPE_GWP_min contributes incrementally to circularity axis 812. Starting approximately in 2035, adoption of LinAlkArom_PE_18, corresponding to linear alkyl benzenes from waste polyethylene, causes a step increase in monetary circularity that exceeds the threshold of 1.0, satisfying circularity target milestone 816. At net-zero milestone 806 in 2050, adoption of AlkHyd_PLA_θ_max, corresponding to alkaline hydrolysis of polylactic acid (PLA) to lactic acid, causes a further step increase. The monetary circularity value remains above 1.0 throughout the remainder of the time horizon, confirming that the circularity constraint is satisfied on a continuing basis from 2035 onward. The progressive increases in circularity depicted in circularity profile graph 810 reflect transitions away from incumbent value-chains toward circular innovations as selected by multiperiod planning function 300 (see FIG. 3).

The term θ as depicted on circularity axis 812 is defined as the ratio of monetary value restored through circular flows to the manufacturing cost. This metric and its threshold are consistent with the US Plastics Pact target and other organizational circularity constraints, as described with respect to the optimization formulation herein.

FIG. 8C depicts cost objective graph 820, illustrating operating costs associated with selected value-chain configurations over time for the proposed optimal roadmap under the SSP2 RCP 3.4 scenario, in accordance with aspects of this disclosure.

Cost objective graph 820 presents operating cost axis 822 on the vertical axis, representing annualized value-chain operating cost expressed in billion United States dollars (USD) per year, ranging from 0.00 to 0.35, and year axis 824 on the horizontal axis, spanning from 2020 through 2060.

Cost objective graph 820 depicts stacked area profiles corresponding to the same four value-chain configurations identified in the legend: the current configuration, AlkHyd_PLA_θ_max, LinAlkArom_PE_18, and pyLDPE_GWP_min. From 2020 through approximately 2024, the current configuration dominates operating cost axis 822, with total operating costs near 0.30 billion USD per year. Beginning in approximately 2025, the shift to pyLDPE_GWP_min reduces total operating costs substantially to approximately 0.05 to 0.08 billion USD per year, reflecting the lower life-cycle cost of natural resources associated with the pyrolysis-based value-chain. Cost objective graph 820 illustrates the fluctuations in operating expenses as net-zero framework 170 (see FIG. 1) shifts consumer demand between various innovative Pareto-optimal solutions across the time horizon. Operating costs remain relatively low from approximately 2025 through 2049. Beginning in approximately 2050, adoption of AlkHyd_PLA_θ_max causes a step increase in operating costs to approximately 0.15 billion USD per year, reflecting the higher resource costs associated with the bio-based PLA alkaline hydrolysis pathway. Operating costs subsequently decrease and stabilize at approximately 0.10 billion USD per year through 2060.

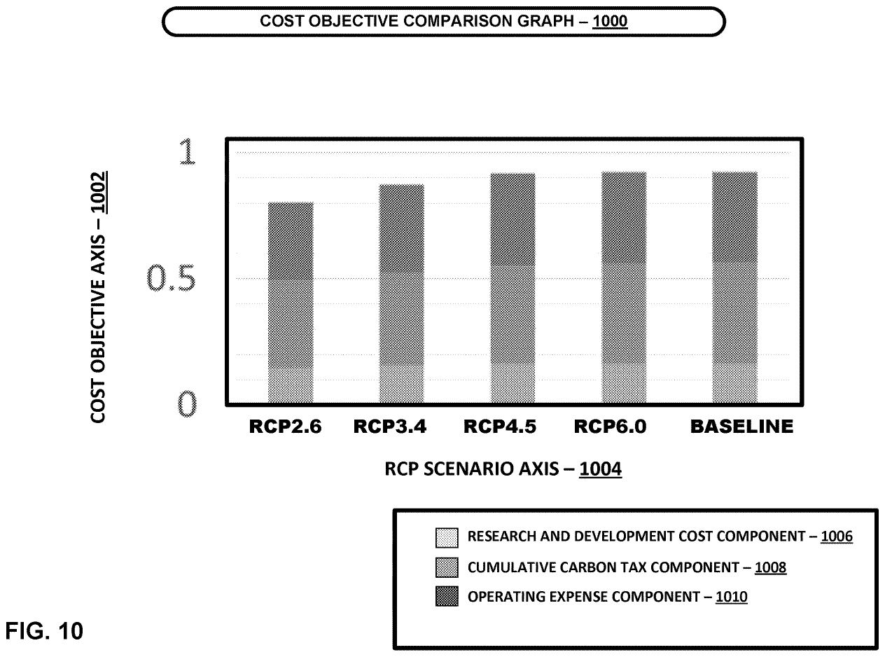

The operating cost profiles depicted in cost objective graph 820 correspond to value-chain operating cost 340 within objective function 310 (see FIG. 3), representing the present value of operating expense (OPEX) of the selected compromise solutions on the Pareto fronts within the time horizon, estimated using the life-cycle cost of natural resources recorded in the input dataset. The overall cost objective minimized by multiperiod planning function 300 includes value-chain operating cost 340, research and development cost 342, and cumulative emissions cost 344, with the profiles in cost objective graph 820 reflecting the operating cost component only. As future climate change scenarios worsen, the overall cost objective deteriorates due to the need for more expensive investments and higher carbon budget utilization, as further illustrated in FIG. 10.

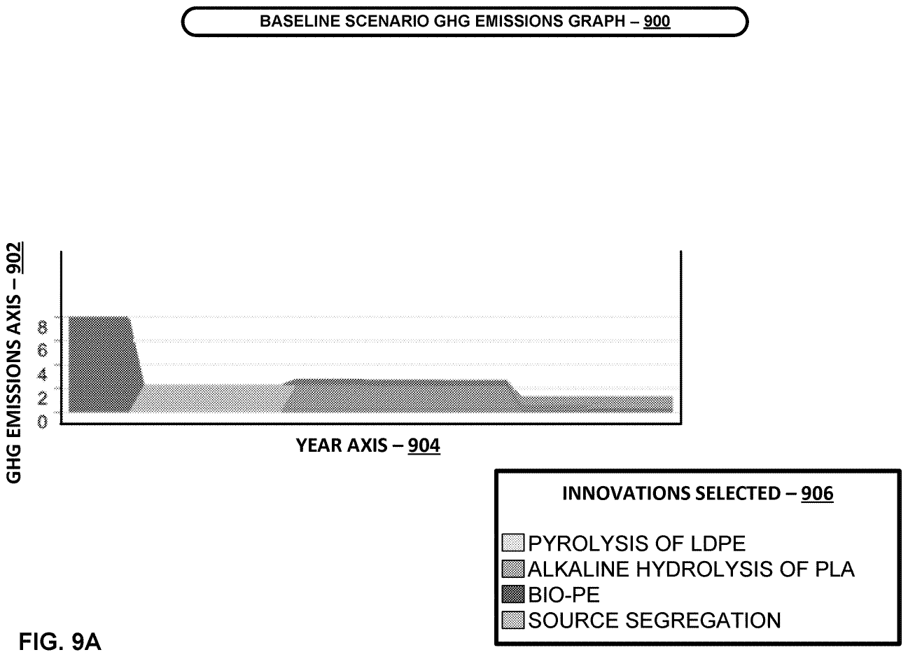

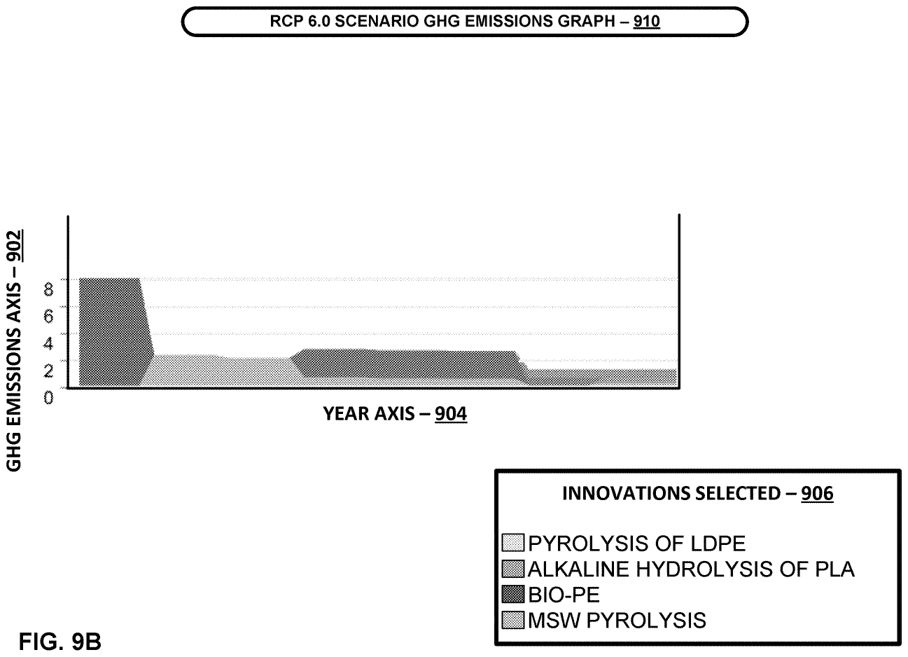

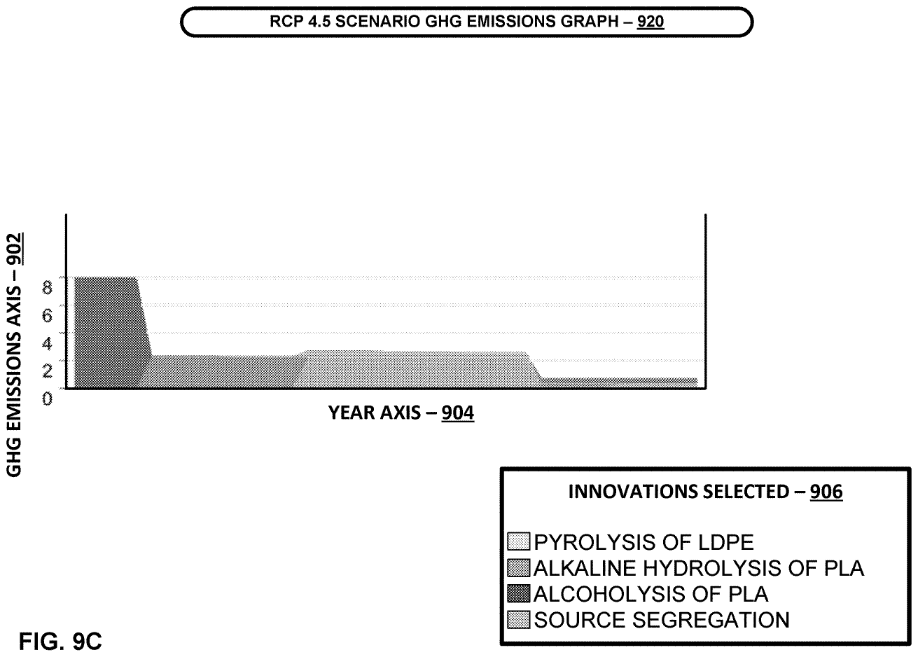

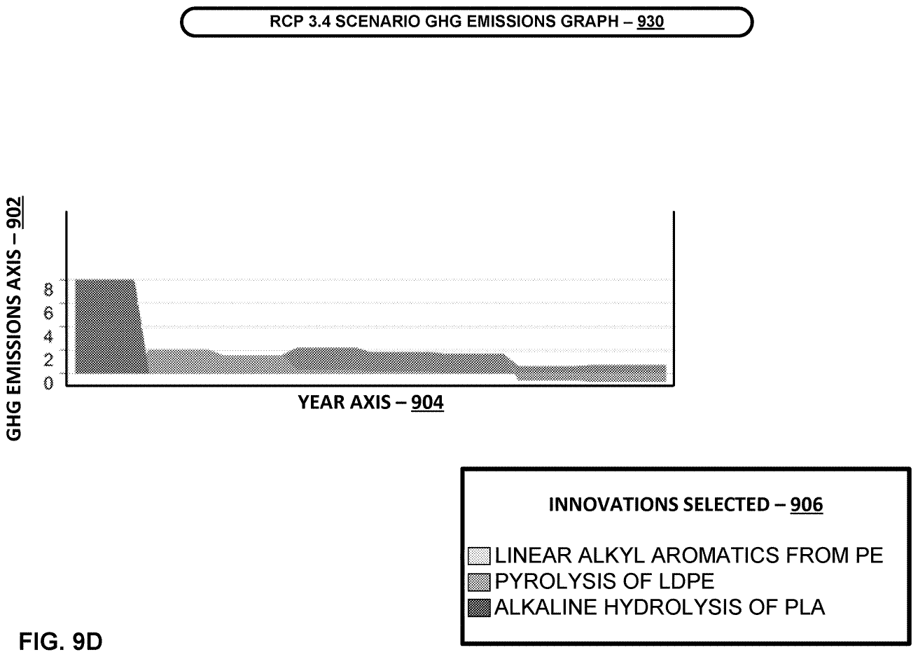

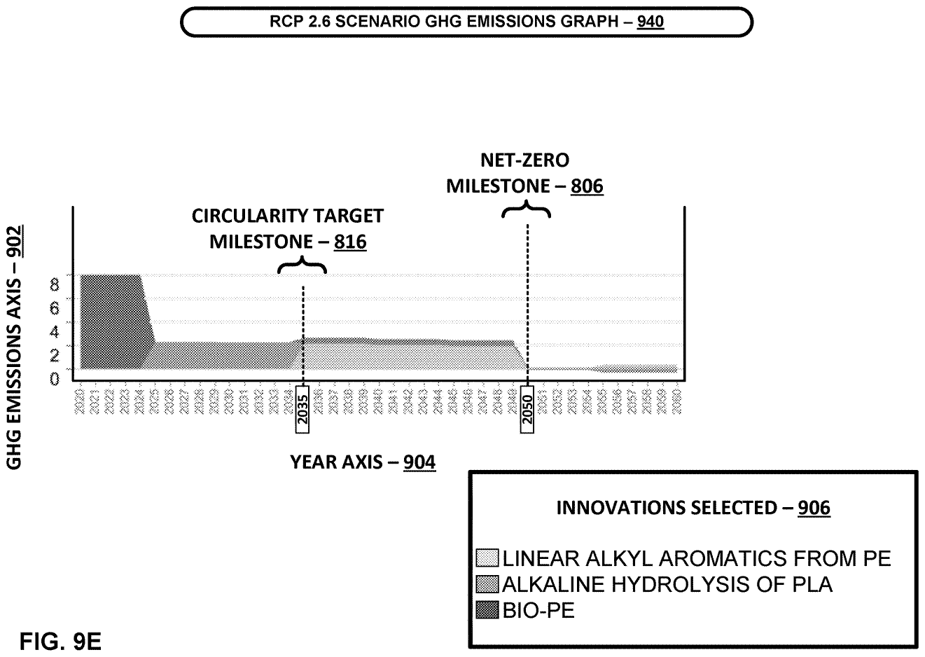

FIG. 9A depicts baseline scenario greenhouse gas (GHG) emissions graph 900, illustrating GHG emissions profiles for the optimal roadmap under the baseline climate scenario within the shared socioeconomic pathway (SSP2), in accordance with aspects of this disclosure.

Baseline scenario GHG emissions graph 900 presents GHG emissions axis 902 on the vertical axis, representing GHG emissions expressed in units of ×10³ million kgCO₂ equivalent per year, and year axis 904 on the horizontal axis. Innovations selected 906 identifies the innovations chosen by multiperiod planning function 300 (see FIG. 3) as part of transition roadmap output 176 (see FIG. 1) under the baseline scenario as: pyrolysis of low-density polyethylene (LDPE), alkaline hydrolysis of poly-lactic acid (PLA), bio-polyethylene (bio-PE), and source segregation.

Under the baseline scenario, net-zero GHG emissions from the grocery bags value-chain are not achievable by 2050. The baseline scenario corresponds to a future in which no stringent climate action policy is enacted, resulting in minimal grid decarbonization over the time horizon. As depicted in baseline scenario GHG emissions graph 900, the optimal combination of innovations drawn from innovations selected 906 can reduce emissions substantially from initial levels but cannot bring total life-cycle GHG emissions to zero by 2050. The baseline scenario can reduce approximately 83% of emissions from the grocery bags value-chain, with residual emissions persisting due to high scope 2 and scope 3 emissions from upstream life-cycle processes that are not sufficiently offset under this scenario.

FIG. 9B depicts RCP 6.0 scenario GHG emissions graph 910, illustrating GHG emissions profiles for the optimal roadmap under the representative concentration pathway (RCP) 6.0 scenario within SSP2, in accordance with aspects of this disclosure.

RCP 6.0 scenario GHG emissions graph 910 presents GHG emissions axis 902 on the vertical axis and year axis 904 on the horizontal axis, consistent with the axis conventions established in FIG. 9A. Innovations selected 906 identifies the innovations chosen under the RCP 6.0 scenario as: pyrolysis of LDPE, alkaline hydrolysis of PLA, bio-PE, and municipal solid waste (MSW) pyrolysis. The transition from source segregation in the baseline scenario to MSW pyrolysis within innovations selected 906 illustrates how changing background emissions 354 and integrated assessment model 338 (see FIG. 3) parameters influence the selection of optimal futuristic synergies within transition roadmap output 176.

Under the RCP 6.0 scenario, net-zero GHG emissions from the grocery bags value-chain are not achievable by 2050. The RCP 6.0 scenario corresponds to a radiative forcing of 6.0 W/m² by 2050, reflecting relatively low climate action stringency and correspondingly limited grid decarbonization. As depicted in RCP 6.0 scenario GHG emissions graph 910, the optimal combination of innovations drawn from innovations selected 906 can reduce approximately 85% of emissions from the grocery bags value-chain, with residual emissions persisting through the time horizon for the same underlying reasons as the baseline scenario.

FIG. 9C depicts RCP 4.5 scenario GHG emissions graph 920, illustrating GHG emissions profiles for the optimal roadmap under the RCP 4.5 scenario within SSP2, in accordance with aspects of this disclosure.

RCP 4.5 scenario GHG emissions graph 920 presents GHG emissions axis 902 on the vertical axis and year axis 904 on the horizontal axis, consistent with prior subfigures. Innovations selected 906 identifies the innovations chosen under the RCP 4.5 scenario as: pyrolysis of LDPE, alkaline hydrolysis of PLA, alcoholysis of PLA, and source segregation.

Under the RCP 4.5 scenario, net-zero GHG emissions from the grocery bags value-chain are not achievable by 2050. The RCP 4.5 scenario corresponds to a radiative forcing of 4.5 W/m² by 2050, representing an intermediate level of climate action. As depicted in RCP 4.5 scenario GHG emissions graph 920, the optimal combination of innovations drawn from innovations selected 906 can mitigate approximately 91% of emissions from the grocery bags value-chain by 2050. This indicates that even under an intermediate climate action scenario, it will not be possible for the grocery bags value-chain to meet a net-zero emission goal due to high scope 2 and scope 3 emissions from upstream life-cycle processes that are insufficiently offset by grid decarbonization at this radiative forcing level.

FIG. 9D depicts RCP 3.4 scenario GHG emissions graph 930, illustrating GHG emissions profiles for the optimal roadmap under the RCP 3.4 scenario within SSP2, in accordance with aspects of this disclosure.

RCP 3.4 scenario GHG emissions graph 930 presents GHG emissions axis 902 on the vertical axis and year axis 904 on the horizontal axis, consistent with prior subfigures. Innovations selected 906 identifies the innovations chosen under the RCP 3.4 scenario as: linear alkyl aromatics from polyethylene (PE), pyrolysis of LDPE, and alkaline hydrolysis of PLA.

Under the RCP 3.4 scenario, net-zero GHG emissions from the grocery bags value-chain are achievable by 2050. The RCP 3.4 scenario corresponds to a radiative forcing of 3.4 W/m² by 2050, representing a more stringent level of climate action and correspondingly greater grid decarbonization compared to less ambitious scenarios. As depicted in RCP 3.4 scenario GHG emissions graph 930, the optimal combination of innovations drawn from innovations selected 906 reduces total life-cycle GHG emissions to net-zero within the time horizon. RCP 3.4 represents the least stringent scenario under which net-zero emissions from the grocery bags value-chain remain achievable by 2050 under SSP2 assumptions. Scenarios with a radiative forcing greater than 3.4 W/m² do not provide sufficient background decarbonization to enable the remaining emissions gap to be closed by available innovations.

FIG. 9E depicts RCP 2.6 scenario GHG emissions graph 940, illustrating GHG emissions profiles for the optimal roadmap under the RCP 2.6 scenario within SSP2, in accordance with aspects of this disclosure.

RCP 2.6 scenario GHG emissions graph 940 presents GHG emissions axis 902 on the vertical axis and year axis 904 on the horizontal axis, consistent with prior subfigures. Circularity target milestone 816 is indicated at year 2035, consistent with the corresponding milestone depicted in circularity profile graph 810 (see FIG. 8B), marking the point at which the circularity threshold is satisfied. Net-zero milestone 806 is indicated at year 2050, consistent with the corresponding milestone depicted in GHG emissions profile graph 800 (see FIG. 8A) and circularity profile graph 810. Innovations selected 906 identifies the innovations chosen under the RCP 2.6 scenario as: linear alkyl aromatics from PE, alkaline hydrolysis of PLA, and bio-PE. Placement of net-zero milestone 806 at year 2050 and circularity target milestone 816 at year 2035 within RCP 2.6 scenario GHG emissions graph 940 demonstrates how multiperiod planning function 300 generates transition roadmap output 176 that satisfies environmental targets under stringent climate policy constraints.

Under the RCP 2.6 scenario, net-zero GHG emissions from the grocery bags value-chain are achievable by 2050. The RCP 2.6 scenario corresponds to a radiative forcing of 2.6 W/m² by 2050, representing the most stringent climate action scenario modeled, with the greatest degree of grid decarbonization over the time horizon. As depicted in RCP 2.6 scenario GHG emissions graph 940, total life-cycle GHG emissions reach net-zero at net-zero milestone 806 in 2050 and continue to decline beyond zero through 2060, reflecting the contribution of bio-PE through biogenic carbon sequestration under this scenario.

Comparison across FIGS. 9A, 9B, 9C, 9D, and 9E demonstrates how net-zero framework 170 adapts transition roadmap output 176 based on climate change scenarios. As scenarios progress from the baseline toward RCP 2.6, net-zero framework 170 identifies different combinations for innovations selected 906 to account for varying upstream emissions and policy requirements driven by changing background emissions 354 and integrated assessment model 338. Innovations that are robust to climate change policy are identified on the basis of their selection across more than three RCP radiative forcing scenarios. These robust innovations are: pyrolysis of LDPE using a fluidized catalytic cracking (FCC) catalyst, alkaline hydrolysis of PLA to lactic acid, and bio-based polyethylene at scale. Net-zero framework 170 may therefore be used by companies and organizations not only to plan sustainability transitions to net-zero at the lowest cost, but also to identify investment alternatives that provide robustness to future climate action policies.

As depicted in FIG. 10, worsening future scenarios correspond to higher investment costs and carbon taxes within the cost minimization objective of objective function 310 (see FIG. 3). The multiperiod planning model may be implemented under several configurable constraints and projections aimed at reaching the targets set for the grocery bags value-chain. The main targets are: (1) net-zero GHG emissions by 2050, calculated for a life-cycle system boundary; and (2) upcycling, from 2035 onwards, indicated by the monetary circularity value exceeding 1 (θ≥1). The term θ is defined as the ratio of monetary value restored through circular flows to the manufacturing cost.

While most aspects of the case study are realistic and can be introduced with high confidence, some elements are educated estimates for the prototype, particularly the research and development marginal cost per readiness level increase (MCRL), continuous-time Markov chain (CTMC) parameters, carbon tax rate, and others. For instance, the MCRL has been arbitrarily set to 10 million USD per readiness level increase due to a lack of data, and it is kept consistent across all innovations to avoid biasing the solution. Additionally, the modeling of CTMCs for several innovations depends on subjective inputs from industrial stakeholders and currently lacks a quantitative basis. The future cost of carbon dioxide emissions is assumed to be a static $120 per ton, although this is likely to evolve over the time horizon. Future work aims to address these practical challenges by using uncertainty quantification, robust optimization, fitting CTMC parameters with historical data, and implementing appropriate slab-wise carbon costing models. The results presented should therefore be viewed as an application of net-zero framework 170, with special attention given to its ability to provide optimal roadmaps with numerous considerations, rather than identifying exact solutions and promising innovations for the grocery bags case study.

The outcome of implementing multiperiod planning function 300 provided by net-zero framework 170 is a Gantt chart representing the adoption of various innovative Pareto-optimal value-chain solutions at different points in time. For the RCP 3.4 scenario under SSP2, the optimal Gantt chart is shown in optimal roadmap fractional demand graph 700 (see FIG. 7). The corresponding GHG emissions, circularity, and operating cost profiles across the time horizon are shown in FIGS. 8A, 8B, and 8C. These results show that pyrolysis of sorted LDPE using an FCC catalyst is chosen for immediate investment, as it reduces the exploitation of carbon budgets at the lowest cost. Next, linear alkyl benzenes are selected starting in 2035, after reaching a sufficient TRL, ensuring that upcycling requirements are met. Ultimately, bio-based PLA bags are selected starting in 2050, as they contribute to emission reduction by displacing conventional lactic acid through alkaline hydrolysis and biogenic carbon sequestration. Despite an initial low TRL, this innovation is expected to evolve positively according to the CTMCs depicted in stochastic technology forecasting graph 600 (see FIG. 6). This, combined with the lower time value of money in the future, encourages a later investment and shift toward bio-based PLA alternatives. Life-cycle GHG emissions reach net-zero starting in 2050, and circularity targets are met by 2035, as depicted in FIGS. 8A, 8B, and 8C. This roadmap takes into account various phenomena including technology evolution, climate change policy, and annualized operating and research and development costs, and provides a comprehensive transition roadmap output 176 (see FIG. 1) for meeting environmental targets at the lowest cost.

Net-zero framework 170 may therefore be used by companies and organizations not only to plan sustainability transitions to net-zero at the lowest cost, but also to identify investment alternatives that would help them remain robust to future climate action policies. As future scenarios worsen, the cost objective also deteriorates due to the need for more expensive investments and higher carbon budget utilization, as illustrated in FIG. 10. This implies that an optimal roadmap to a carbon-neutral, sustainable circular economy would encourage the industry, especially the plastic packaging sector, to support and back sustainability-related climate action policies throughout the entire supply chain.

In such a way, net-zero framework 170 enables the design of optimal roadmaps to meet corporate or national environmental targets related to greenhouse gas emissions and circularity, while minimizing investment and operating costs. Net-zero framework 170 also takes into account the effects of changing climate action policies and evolving technology readiness levels, based on stochastic models. Net-zero framework 170 is generalizable such that it may be applicably configured to any product system or supply chain, with input data in the form of either innovative Pareto fronts developed using prior research or a set of alternative value-chain options corresponding to each innovation. The outcomes of net-zero framework 170 include: (a) a minimal cost roadmap to meet targets, (b) an investment strategy detailing what and when decisions should be made, (c) an assessment of the potential for achieving environmental targets under different climate change scenarios, and (d) identification of innovations that are robust to climate action policies.

Net-zero framework 170, via the case study described above, has been applied to guide sustainability transitions within the grocery bags value-chain network, incorporating innovations from the packaging technology, social behavior, feedstock manufacturing, and several other domains. From the 10 screened eco-innovations targeted at achieving a sustainable circular economy within the grocery bags value-chain, a proposed optimal roadmap will likely prioritize three alternatives to meet the set targets: advanced pyrolysis of low-density polyethylene waste to fuel, alkaline hydrolysis of polylactic acid to lactic acid, and bio-based polyethylene. These innovations are robust across multiple possible climate change scenarios and corresponding policies, ensuring minimal utilization of carbon budgets by reducing cumulative greenhouse gas emissions.

Net-zero framework 170, as demonstrated by the case study, serves as a valuable tool for industry and policymakers, guiding future transitions toward net-zero greenhouse gas emissions and circularity. Net-zero framework 170 considers holistic life-cycle system boundaries, future climate change scenarios, and forecasts of technology evolution. Net-zero framework 170 may be extended to incorporate models for technology forecasting, which may be validated using historical data from clusters of similar technologies. Additionally, a multistage stochastic optimization extension to net-zero framework 170 enables recourse action at intermediate time periods once the readiness levels of innovations and/or climate change scenarios can be realized. Moreover, a detailed sensitivity analysis will be conducted to examine the impact of parameters such as carbon tax in USD per ton, research and development costs, and discounting rates on optimal roadmap selection.

FIG. 10 depicts cost objective comparison graph 1000, illustrating the relationship between climate change scenarios and the corresponding total cost objectives for the grocery bags value-chain, in accordance with aspects of this disclosure.

Cost objective comparison graph 1000 presents cost objective axis 1002 on the vertical axis, representing total cost objective expressed in billion United States dollars (USD), ranging from 0 to 1, and representative concentration pathway (RCP) scenario axis 1004 on the horizontal axis, identifying five climate change scenarios: RCP 2.6, RCP 3.4, RCP 4.5, RCP 6.0, and baseline. Each bar in cost objective comparison graph 1000 represents the total cost objective for the optimal roadmap generated by net-zero framework 170 (see FIG. 1) under the corresponding scenario, decomposed into three stacked cost components. These comparisons enable technology integrator 175 (see FIG. 1) to generate transition roadmap output 176 that accounts for the economic impacts of varying climate policy stringency across RCP scenario axis 1004.

Research and development cost component 1006 represents the portion of the total cost objective attributable to research and development investments required to advance innovations to sufficient technology readiness levels (TRLs) for adoption, as described with respect to research and development cost 342 within objective function 310 (see FIG. 3). Cumulative carbon tax component 1008 represents the portion of the total cost objective attributable to carbon taxes applied to cumulative greenhouse gas (GHG) emissions accrued throughout the time horizon, as described with respect to cumulative emissions cost 344 within objective function 310. Operating expense component 1010 represents the portion of the total cost objective attributable to value-chain operating costs across the time horizon, as described with respect to value-chain operating cost 340 within objective function 310. Multiperiod planning function 300 (see FIG. 3) minimizes the sum of research and development cost component 1006, cumulative carbon tax component 1008, and operating expense component 1010 to achieve net-zero targets while satisfying constraints 315.

As depicted in cost objective comparison graph 1000, the total cost objective increases as climate change scenarios become less stringent, progressing from RCP 2.6 toward the baseline scenario along RCP scenario axis 1004. Under the RCP 2.6 scenario, the total cost objective is lowest, approximately 0.8 billion USD, reflecting the benefit of stringent grid decarbonization reducing scope 2 and scope 3 emissions and thereby lowering cumulative carbon tax component 1008. Under the RCP 3.4, RCP 4.5, RCP 6.0, and baseline scenarios, the total cost objective increases progressively, reaching approximately 0.9 to 0.95 billion USD, driven primarily by growth in cumulative carbon tax component 1008 and research and development cost component 1006. Operating expense component 1010 remains relatively consistent across all five scenarios, indicating that the variation in total cost objective across RCP scenario axis 1004 is attributable primarily to carbon tax exposure and research and development investment requirements rather than to operating cost differences.

Cost objective comparison graph 1000 illustrates that an optimal roadmap to a carbon-neutral, sustainable circular economy would encourage the industry, especially the plastic packaging sector, to support sustainability-related climate action policies throughout the entire supply chain. Companies and organizations that back more stringent climate action policies benefit from lower carbon tax burdens and reduced research and development costs, as greater grid decarbonization reduces the emissions gap that innovations must close. This finding reinforces the strategic value of net-zero framework 170 as a tool for guiding both internal investment decisions and external policy advocacy within value-chain networks.

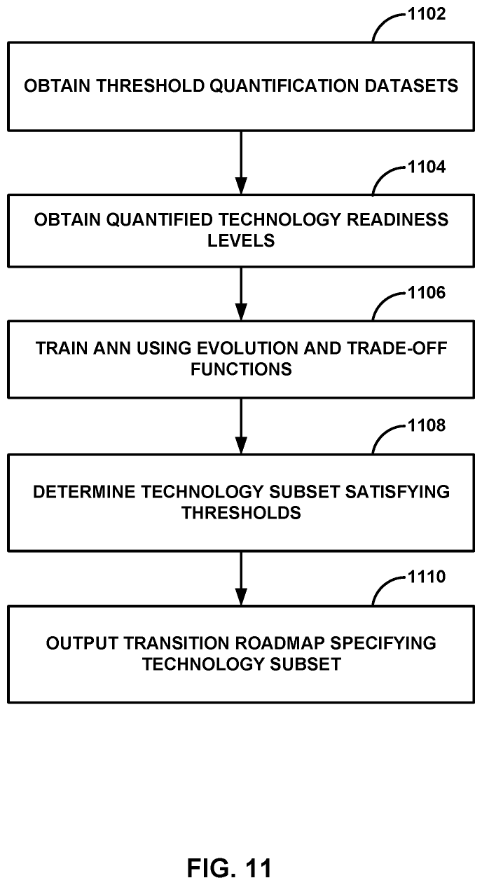

FIG. 11 is a flow diagram illustrating an example method for using an artificial neural network (ANN) to generate a transition roadmap for net-zero emissions and circularity, in accordance with aspects of this disclosure. FIG. 11 is described with respect to computing device 100 of FIG. 1, including processor(s) 102, memory 104, net-zero framework 170, AI/optimization engine 198, artificial neural network 180, evolution function 182, trade-off evaluation engine 190, technology attribute collector 195, technology readiness levels 186, technology integrator 175, and transition roadmap output 176. However, techniques of FIG. 11 may be performed by different or alternative systems.

Processing circuitry of computing device 100 may be configured to obtain threshold quantification datasets (1102). For example, technology attribute collector 195 may be configured to obtain one or more datasets quantifying a circularity threshold and a life-cycle environmental impact threshold over a configurable time horizon for the transition roadmap.

Processing circuitry of computing device 100 may be configured to obtain quantified technology readiness levels (1104). For example, technology attribute collector 195 may be configured to obtain quantified technology readiness levels (TRLs) for a plurality of transition technologies.

Processing circuitry of computing device 100 may be configured to train ANN using evolution and trade-off functions (1106). For example, AI/optimization engine 198 may be configured to train artificial neural network 180 based on the one or more datasets and a selected training algorithm, to generate a trained ANN, wherein the selected training algorithm includes evolution function 182 applied to the plurality of transition technologies using the quantified TRLs and a trade-off function executed by trade-off evaluation engine 190 to predict whether the circularity threshold or the life-cycle environmental impact threshold are satisfied at varying evolution points of the transition technologies.

Processing circuitry of computing device 100 may be configured to determine technology subset satisfying thresholds (1108). For example, AI/optimization engine 198 may be configured to determine, using trained artificial neural network 180, at least a subset of the transition technologies at the varying evolution points for the subset of the transition technologies that satisfy both the circularity threshold and the life-cycle environmental impact threshold across an entirety of the configurable time horizon for the transition roadmap.

Processing circuitry of computing device 100 may be configured to output transition roadmap specifying technology subset (1110). For example, technology integrator 175 may be configured to generate transition roadmap output 176 specifying the subset of the transition technologies relative to the configurable time horizon.

In this way, FIG. 11 illustrates a method for using an ANN to generate a transition roadmap for net-zero emissions and circularity through quantification of environmental and circularity thresholds, stochastic technology forecasting, and multi-objective trade-off evaluation, enabling systematic identification of optimal technology pathways that satisfy complex sustainability constraints across a multiperiod time horizon.

This disclosure includes the following examples.
Example 1—A method of using an artificial neural network (ANN) to generate a transition roadmap for net-zero emissions and circularity, comprising: obtaining one or more datasets quantifying a circularity threshold and a life-cycle environmental impact threshold over a configurable time horizon for the transition roadmap; obtaining quantified technology readiness levels (TRLs) for a plurality of transition technologies; training, by a computer, the ANN based on the one or more datasets and a selected training algorithm, to generate a trained ANN, wherein the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies; determining, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap; and outputting the transition roadmap specifying the subset of the transition technologies relative to the configurable time horizon.
Example 2—The method of Example 1, further comprising: obtaining the one or more datasets quantifying the circularity threshold and the life-cycle environmental impact threshold and further quantifying a sustainability threshold and a cost efficiency threshold; and determining, using the trained ANN, at least the subset of the transition technologies at the varying evolution points for the subset of the transition technologies that satisfy each of the circularity threshold, the life-cycle environmental impact threshold, the sustainability threshold, and the cost efficiency threshold.
Example 3—The method of Example 1, further comprising: training the ANN based on the one or more datasets and the selected training algorithm, to generate the trained ANN, wherein the selected training algorithm further includes a Pareto fronts function to quantify trade-offs between a circularity value and a life-cycle environmental impact value for the transition technologies at the varying evolution points based on the quantified TRLs.
Example 4—The method of Example 3, further comprising: determining, using the trained ANN, a predicted best pathway to net-zero transition utilizing at least the subset of the transition technologies at the varying evolution points for the subset of the transition technologies based on the trade-offs quantified between the circularity value and the life-cycle environmental impact value for the transition technologies.
Example 5—The method of Example 3, further comprising: determining, using the trained ANN, a predicted best pathway to net-zero transition using material circularity indicators and circulytics metrics to assess circularity for each of a plurality of value-chain configurations for the subset of the transition technologies.
Example 6—The method of Example 3, further comprising: determining, using the trained ANN, one or more predicted innovation hotspots corresponding to one or more of the subset of the transition technologies that satisfy a life-cycle environmental impact threshold; and outputting with the transition roadmap an investment recommendation specifying the one or more predicted innovation hotspots.
Example 7—The method of Example 1, further comprising: obtaining user configuration input specifying metrics for one or more of a greenhouse gas emission threshold, the circularity threshold, a total cost threshold, a cost efficiency threshold, and the life-cycle environmental impact threshold.
Example 8—The method of Example 1, further comprising: training the ANN based on the one or more datasets and the selected training algorithm, to generate the trained ANN, wherein the selected training algorithm includes a multi-period planning function to determine timing of investment into the subset of the transition technologies and timing of adoption of the subset of the transition technologies; and outputting the transition roadmap specifying the subset of the transition technologies relative to the configurable time horizon, the timing of investment into the subset of the transition technologies, and the timing of adoption of the subset of the transition technologies.
Example 9—The method of Example 1, further comprising: obtaining environmental targets for the transition roadmap, wherein obtaining the environmental targets includes using ReCiPe impact assessment factors to calculate a global warming potential (GWP) from value-chain emissions.
Example 10—The method of Example 1, further comprising: ranking at least the subset of the transition technologies based on their effect on a sustainability value, a greenhouse gas emissions value, and cost value.
Example 11—A system comprising: processing circuitry; non-transitory computer-readable media configurable to use an artificial neural network (ANN) to generate a transition roadmap for net-zero emissions and circularity; and instructions that, when executed by the processing circuitry, configure the processing circuitry to: obtain one or more datasets quantifying a circularity threshold and a life-cycle environmental impact threshold over a configurable time horizon for the transition roadmap; obtain quantified technology readiness levels (TRLs) for a plurality of transition technologies; train the ANN based on the one or more datasets and a selected training algorithm, to generate a trained ANN, wherein the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies; determine, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap; and output the transition roadmap specifying the subset of the transition technologies relative to the configurable time horizon.
Example 12—The system of Example 11, wherein the instructions, when executed by the processing circuitry, further configure the processing circuitry to: obtain the one or more datasets quantifying the circularity threshold and the life-cycle environmental impact threshold and further quantifying a sustainability threshold and a cost efficiency threshold; and determine, using the trained ANN, at least the subset of the transition technologies at the varying evolution points for the subset of the transition technologies that satisfy each of the circularity threshold, the life-cycle environmental impact threshold, the sustainability threshold, and the cost efficiency threshold.
Example 13—The system of Example 11, wherein the instructions, when executed by the processing circuitry, further configure the processing circuitry to: train the ANN based on the one or more datasets and the selected training algorithm, to generate the trained ANN, wherein the selected training algorithm further includes a Pareto fronts function to quantify trade-offs between a circularity value and a life-cycle environmental impact value for the transition technologies at the varying evolution points based on the quantified TRLs.
Example 14—The system of Example 13, wherein the instructions, when executed by the processing circuitry, further configure the processing circuitry to: determine, using the trained ANN, a predicted best pathway to net-zero transition utilizing at least the subset of the transition technologies at the varying evolution points for the subset of the transition technologies based on the trade-offs quantified between the circularity value and the life-cycle environmental impact value for the transition technologies.
Example 15—The system of Example 13, wherein the instructions, when executed by the processing circuitry, further configure the processing circuitry to: determine, using the trained ANN, a predicted best pathway to net-zero transition using material circularity indicators and circulytics metrics to assess circularity for each of a plurality of value-chain configurations for the subset of the transition technologies.
Example 16—The system of Example 13, wherein the instructions, when executed by the processing circuitry, further configure the processing circuitry to: determine, using the trained ANN, one or more predicted innovation hotspots corresponding to one or more of the subset of the transition technologies that satisfy the life-cycle environmental impact threshold; and output with the transition roadmap an investment recommendation specifying the one or more predicted innovation hotspots.
Example 17—The system of Example 11, wherein the instructions, when executed by the processing circuitry, further configure the processing circuitry to: obtain user configuration input specifying metrics for one or more of a greenhouse gas emission threshold, the circularity threshold, a total cost threshold, a cost efficiency threshold, and the life-cycle environmental impact threshold.
Example 18—The system of Example 11, wherein the instructions, when executed by the processing circuitry, further configure the processing circuitry to: train the ANN based on the one or more datasets and the selected training algorithm, to generate the trained ANN, wherein the selected training algorithm includes a multi-period planning function to determine timing of investment into the subset of the transition technologies and timing of adoption of the subset of the transition technologies; and output the transition roadmap specifying the subset of the transition technologies relative to the configurable time horizon, the timing of investment into the subset of the transition technologies, and the timing of adoption of the subset of the transition technologies.
Example 19—The system of Example 11, wherein the instructions, when executed by the processing circuitry, further configure the processing circuitry to: obtain environmental targets for the transition roadmap, wherein to obtain the environmental targets includes the processing circuitry to use ReCiPe impact assessment factors to calculate a global warming potential (GWP) from value-chain emissions.
Example 20—Computer-readable storage media comprising instructions that, when executed, configure processing circuitry to: obtain one or more datasets quantifying a circularity threshold and a life-cycle environmental impact threshold over a configurable time horizon for a transition roadmap; obtain quantified technology readiness levels (TRLs) for a plurality of transition technologies; train an artificial neural network (ANN) to generate the transition roadmap for net-zero emissions and circularity based on the one or more datasets and a selected training algorithm, to generate a trained ANN, wherein the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies; determine, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap; and output the transition roadmap specifying the subset of the transition technologies relative to the configurable time horizon.
Example 21—A computer program product comprising one or more instructions that, when executed by at least one processor, cause the at least one processor to perform any of the methods of Examples 1-10.
Example 22—A device comprising means for performing any of the methods of Examples 1-10.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method of using an artificial neural network (ANN) to generate a transition roadmap for net-zero emissions and circularity, comprising:
obtaining one or more datasets quantifying a circularity threshold and a life-cycle environmental impact threshold over a configurable time horizon for the transition roadmap;
obtaining quantified technology readiness levels (TRLs) for a plurality of transition technologies;
training, by a computer, the ANN based on the one or more datasets and a selected training algorithm, to generate a trained ANN, wherein the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies;
determining, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap; and
outputting the transition roadmap specifying the subset of the transition technologies relative to the configurable time horizon.

2. The method of claim 1, further comprising:
obtaining the one or more datasets quantifying the circularity threshold and the life-cycle environmental impact threshold and further quantifying a sustainability threshold and a cost efficiency threshold; and
determining, using the trained ANN, at least the subset of the transition technologies at the varying evolution points for the subset of the transition technologies that satisfy each of the circularity threshold, the life-cycle environmental impact threshold, the sustainability threshold, and the cost efficiency threshold.

3. The method of claim 1, further comprising:
training the ANN based on the one or more datasets and the selected training algorithm, to generate the trained ANN, wherein the selected training algorithm further includes a Pareto fronts function to quantify trade-offs between a circularity value and a life-cycle environmental impact value for the transition technologies at the varying evolution points based on the quantified TRLs.

4. The method of claim 3, further comprising:
determining, using the trained ANN, a predicted best pathway to net-zero transition utilizing at least the subset of the transition technologies at the varying evolution points for the subset of the transition technologies based on the trade-offs quantified between the circularity value and the life-cycle environmental impact value for the transition technologies.

5. The method of claim 3, further comprising:
determining, using the trained ANN, a predicted best pathway to net-zero transition using material circularity indicators and circulytics metrics to assess circularity for each of a plurality of value-chain configurations for the subset of the transition technologies.

6. The method of claim 3, further comprising:
determining, using the trained ANN, one or more predicted innovation hotspots corresponding to one or more of the subset of the transition technologies that satisfy the life-cycle environmental impact threshold; and
outputting with the transition roadmap an investment recommendation specifying the one or more predicted innovation hotspots.

7. The method of claim 1, further comprising:
obtaining user configuration input specifying metrics for one or more of a greenhouse gas emission threshold, the circularity threshold, a total cost threshold, a cost efficiency threshold, and the life-cycle environmental impact threshold.

8. The method of claim 1, further comprising:
training the ANN based on the one or more datasets and the selected training algorithm, to generate the trained ANN, wherein the selected training algorithm includes a multi-period planning function to determine timing of investment into the subset of the transition technologies and timing of adoption of the subset of the transition technologies; and
outputting the transition roadmap specifying the subset of the transition technologies relative to the configurable time horizon, the timing of investment into the subset of the transition technologies, and the timing of adoption of the subset of the transition technologies.

9. The method of claim 1, further comprising:
obtaining environmental targets for the transition roadmap, wherein obtaining the environmental targets includes using ReCiPe impact assessment factors to calculate a global warming potential (GWP) from value-chain emissions.

10. The method of claim 1, further comprising:
ranking at least the subset of the transition technologies based on their effect on a sustainability value, a greenhouse gas emissions value, and cost value.

11. A system comprising:
processing circuitry;
non-transitory computer readable media configurable to use an artificial neural network (ANN) to generate a transition roadmap for net-zero emissions and circularity; and
instructions that, when executed by the processing circuitry, configure the processing circuitry to:
obtain one or more datasets quantifying a circularity threshold and a life-cycle environmental impact threshold over a configurable time horizon for the transition roadmap;
obtain quantified technology readiness levels (TRLs) for a plurality of transition technologies;
train the ANN based on the one or more datasets and a selected training algorithm, to generate a trained ANN, wherein the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies;
determine, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap; and
output the transition roadmap specifying the subset of the transition technologies relative to the configurable time horizon.

12. The system of claim 11, wherein the instructions, when executed by the processing circuitry, further configure the processing circuitry to:
obtain the one or more datasets quantifying the circularity threshold and the life-cycle environmental impact threshold and further quantifying a sustainability threshold and a cost efficiency threshold; and
determine, using the trained ANN, at least the subset of the transition technologies at the varying evolution points for the subset of the transition technologies that satisfy each of the circularity threshold, the life-cycle environmental impact threshold, the sustainability threshold, and the cost efficiency threshold.

13. The system of claim 11, wherein the instructions, when executed by the processing circuitry, further configure the processing circuitry to:
train the ANN based on the one or more datasets and the selected training algorithm, to generate the trained ANN, wherein the selected training algorithm further includes a Pareto fronts function to quantify trade-offs between a circularity value and a life-cycle environmental impact value for the transition technologies at the varying evolution points based on the quantified TRLs.

14. The system of claim 13, wherein the instructions, when executed by the processing circuitry, further configure the processing circuitry to:
determine, using the trained ANN, a predicted best pathway to net-zero transition utilizing at least the subset of the transition technologies at the varying evolution points for the subset of the transition technologies based on the trade-offs quantified between the circularity value and the life-cycle environmental impact value for the transition technologies.

15. The system of claim 13, wherein the instructions, when executed by the processing circuitry, further configure the processing circuitry to:
determine, using the trained ANN, a predicted best pathway to net-zero transition using material circularity indicators and circulytics metrics to assess circularity for each of a plurality of value-chain configurations for the subset of the transition technologies.

16. The system of claim 13, wherein the instructions, when executed by the processing circuitry, further configure the processing circuitry to:
determine, using the trained ANN, one or more predicted innovation hotspots corresponding to one or more of the subset of the transition technologies that satisfy the life-cycle environmental impact threshold; and
output with the transition roadmap an investment recommendation specifying the one or more predicted innovation hotspots.

17. The system of claim 11, wherein the instructions, when executed by the processing circuitry, further configure the processing circuitry to:
obtain user configuration input specifying metrics for one or more of a greenhouse gas emission threshold, the circularity threshold, a total cost threshold, a cost efficiency threshold, and the life-cycle environmental impact threshold.

18. The system of claim 11, wherein the instructions, when executed by the processing circuitry, further configure the processing circuitry to:
train the ANN based on the one or more datasets and the selected training algorithm, to generate the trained ANN, wherein the selected training algorithm includes a multi-period planning function to determine timing of investment into the subset of the transition technologies and timing of adoption of the subset of the transition technologies; and
output the transition roadmap specifying the subset of the transition technologies relative to the configurable time horizon, the timing of investment into the subset of the transition technologies, and the timing of adoption of the subset of the transition technologies.

19. The system of claim 11, wherein the instructions, when executed by the processing circuitry, further configure the processing circuitry to:
obtain environmental targets for the transition roadmap, wherein to obtain the environmental targets includes the processing circuitry to use ReCiPe impact assessment factors to calculate a global warming potential (GWP) from value-chain emissions.

20. Computer-readable storage media comprising instructions that, when executed, configure processing circuitry to:
obtain one or more datasets quantifying a circularity threshold and a life-cycle environmental impact threshold over a configurable time horizon for a transition roadmap;
obtain quantified technology readiness levels (TRLs) for a plurality of transition technologies;
train an artificial neural network (ANN) to generate the transition roadmap for net-zero emissions and circularity based on the one or more datasets and a selected training algorithm, to generate a trained ANN, wherein the selected training algorithm includes an evolution function applied to the plurality of transition technologies using the quantified TRLs and a trade-off function to predict whether the circularity threshold or the life-cycle environmental impact threshold are satisfied at varying evolution points of the transition technologies;
determine, using the trained ANN, at least a subset of the transition technologies at the varying evolution points for the subset of the transition technologies that satisfy both the circularity threshold and the life-cycle environmental impact threshold across an entirety of the configurable time horizon for the transition roadmap; and
output the transition roadmap specifying the subset of the transition technologies relative to the configurable time horizon.
